(19) United States
(12) Patent Application Publication
(10) Pub. No.: US 2019/0197363 A1
(43) Pub. Date: Jun. 27, 2019

(54) COMPUTER-IMPLEMENTED METHODS AND SYSTEMS FOR OPTIMAL LINEAR CLASSIFICATION SYSTEMS

(71) Applicant: Denise Reeves, Burke, VA (US)

(72) Inventor: Denise Reeves, Burke, VA (US)

(73) Assignee: Denise Reeves, Burke, VA (US)

(21) Appl. No.: 15/853,787

(22) Filed: Dec. 23, 2017

(51) Int. Cl. G06K 9/62; G06F 17/30; G06N 7/00; G06F 17/16

(52) U.S. Cl. CPC G06K 9/6278; G06F 17/30271; G06F 17/3028; G06K 9/6265; G06F 17/16; G06K 9/628; G06N 7/005

(57) ABSTRACT

A computer-implemented method for linear classification involves generating a data-driven likelihood ratio test based on a dual locus of likelihoods and principal eigenaxis components that contains Bayes' likelihood ratio and automatically generates the best linear decision boundary. A dual locus of likelihoods and principal eigenaxis components, formed by a locus of weighted extreme points, satisfies fundamental statistical laws for a linear classification system in statistical equilibrium and is the basis of an optimal linear classification system for which the eigenenergy and the Bayes' risk are minimized, so that the classification system achieves Bayes' error rate and exhibits optimal generalization performance. Linear classification systems can be linked with other such systems to perform multiclass linear classification and to fuse feature vectors from different data sources. Linear classification systems also provide a practical statistical gauge that measures data distribution overlap and Bayes' error rate.

### CROSS-REFERENCES TO RELATED APPLICATIONS

This application claims the benefit of U.S. provisional application No. 62/556,185 filed Sep. 8, 2017.

### FIELD OF THE INVENTION

This invention relates generally to learning machines. More particularly, it relates to methods and systems for statistical pattern recognition and statistical classification. This invention is described in an article by applicant, “Design of Data-Driven Mathematical Laws for Optimal Statistical Classification Systems,” arXiv:1612.03902v8: submitted on 22 Sep. 2017.

### BACKGROUND OF THE INVENTION

Statistical pattern recognition and classification methods and systems enable computers to describe, recognize, classify, and group patterns, e.g., digital signals and digital images, such as fingerprint images, human faces, spectral signatures, speech signals, seismic and acoustic waveforms, radar imaaes, multispectral images, and hyperspectral images. Given a pattern, its automatic or computer-implemented recognition or classification may consist of one of the following two tasks; (a) supervised classification (e.g., discriminant analysis) in which the input pattern is identified as a member of a predefined class, (b) unsupervised classification (e.g., clustering) in which the pattern is assigned to a hitherto unknown class.

Automatic or computer-implemented recognition, description, classification and grouping of patterns are important problems that have important applications in a variety of enaineering and scientific fields such as biology, psychology, medicine, computer vision, artificial intelligence, and remote sensing. Computer-implemented classification methods and systems enable the best possible utilization of available sensors, processors, and domain knowledge to make decisions automatically: based on automated processes such as optical character recognition, geometric object recognition, speech recognition, spoken language identification, handwriting recognition, waveform recognition, face recognition, system identification, spectrum identification, fingerprint identification, and DNA sequencing.

The design of statistical pattern recognition systems involves two fundamental problems. The first problem involves identifying measurements or numerical features of the objects being classified and using these measurements to form pattern or feature vectors for each pattern class. For M classes of patterns, a pattern or feature space is composed of M regions, where each region contains the pattern vectors of a class. The second problem involves generating decision boundaries that divide a pattern or feature space into M regions.

A suitable criterion is necessary to determine the best possible partitioning for a given feature space. Bayes' criterion divides a feature space in a manner that minimizes the probability of classification error so that the average risk of the total probability of making a decision error is minimized. Bayes' classifiers are difficult to design because the class-conditional density functions are usually not known. Instead, a collection of training data is used to estimate either decision boundaries or class-conditional density functions.

Machine learning algorithms enable computers to learn either decision boundaries or class-conditional density functions from training data. The estimation error between a learning machine and its target function depends on the training data in a twofold manner: large numbers of parameter estimates raise the variance, whereas incorrect statistical models increase the bias. For this reason, model-free architectures based on insufficient data samples are unreliable and have slow convergence speeds. However, model-based architectures based on incorrect statistical models are also unreliable. Model-based architectures based on accurate statistical models are reliable and have reasonable convergence speeds, but proper statistical models for model-based architectures are difficult to identify. The design of accurate statistical models for learning machines involves the difficult problem of identifying correct forms of equations for statistical models of learning machine architectures.

The design and development of learning machine architectures has primarily been based on curve and surface fitting methods of interpolation or regression, alongside statistical methods of reducing data to minimum numbers of relevant parameters. The generalization performance of any given learning machine depends on a variety of factors, including the quality and quantity of the training data, the complexity of the underlying problem, the learning machine architecture, and the learning algorithm used to train the network.

Machine learning algorithms introduce four sources of error into a classification system: (1) Bayes' error (also known as Bayes' risk), (2) model error or bias, (3) estimation error or variance, and (4) computational errors, e.g., errors in software code. Bayes' error is a result of overlap among statistical distributions and is an inherent source of error in a classification system. As a result, the generalization error of any learning machine whose target function is a classification system includes Bayes' error, modeling error, estimation error, and computational error. The probability of error is the key parameter of all statistical pattern recognition and classification systems. The amount of overlap between data distributions determines the Bayes' error rate which is the lowest error rate and highest accuracy that can be achieved by any statistical classifier. In general, Bayes' error rate is difficult to evaluate.

The generalization error of any learning machine whose target function is a classification system determines the error rate and the accuracy of the classification system. What would be desirable therefore is computer-implemented classification methods and systems for which the generalization error of any given classification system is Bayes' error for M classes of pattern or feature vectors. Further, it would be advantageous to have computer-implemented methods and systems that enable the fusing of classification systems for different data sources. It would also be advantageous to have computer-implemented methods and systems that provide a practical statistical gauge for measuring data distribution overlap and Bayes' error rate for given sets of feature or pattern vectors.

### SUMMARY OF THE INVENTION

The present invention addresses the above needs by providing computer-implemented methods and systems for statistical pattern recognition and classification applications for which the generalization error of any given linear classification system is Bayes' error for M classes of pattern or feature vectors that are drawn from statistical distributions that have similar covariance functions and further computer-implemented methods and systems for fusing feature vectors from different data sources and measuring data distribution overlap and Bayes' error rate for given sets of feature or pattern vectors.

One aspect provides linear classification systems that have the highest accuracy and achieve Bayes' error rate for two sets of feature vectors drawn from statistical distributions that have similar covariance functions. Another aspect provides multiclass linear classification systems that have the highest accuracy and achieve Bayes' error rate for feature vectors drawn from similar or different data sources. Additional aspects will become apparent in view of the following descriptions.

In accordance with an aspect of the invention, a method for computer-implemented, linear classification involves transforming two sets of pattern or feature vectors into a data-driven, likelihood ratio test that is based on a dual locus of likelihoods and principal eigenaxis components formed by a locus of weighted extreme points, all of which determine a point of statistical equilibrium where the opposing forces and influences of a linear classification system are balanced with each other, and the eigenenergy and the Bayes' risk of the classification system are minimized, where each weight specifies a class membership statistic and a conditional density for an extreme point, and each weight determines the magnitude and the total allowed eigenenergy of an extreme vector. A dual locus of likelihoods and principal eigenaxis components contains Bayes' likelihood ratio and delineates the coordinate system of a linear decision boundary. Thereby, a dual locus of likelihoods and principal eigenaxis components is the basis of an optimal linear classification system that implements Bayes' likelihood ratio test: the gold standard of linear classification tasks. A dual locus of likelihoods and principal eigenaxis components is generated by a system of fundamental, data-driven, vector-based locus equations of binary classification for a linear classification system in statistical equilibrium, where the opposing forces and influences of a system are balanced with each other, and the eigenenergy and the corresponding Bayes' risk of a linear classification system are minimized. The method generates the best linear decision boundary for two given sets of feature vectors drawn from statistical distributions that have similar covariance functions and constant or unchanging statistics.

In accordance with yet another aspect of the invention, a method for computer-implemented, multiclass linear classification involves transforming multiple sets of pattern or feature vectors into linear combinations of data-driven, likelihood ratio tests, each of which is based on a dual locus of likelihoods and principal eigenaxis components formed by a locus of weighted extreme points that contains Bayes' likelihood ratio and generates the best linear decision boundary for feature vectors drawn from statistical distributions that have similar covariance functions. Thereby, linear combinations of data-driven, likelihood ratio tests provide M-class linear classification systems for which the eigenenergy and the Bayes' risk of each classification system are minimized, and each classification system is in statistical equilibrium. Moreover, any given M-class linear classification system exhibits the highest accuracy and achieves Bayes' error rate for feature vectors drawn from statistical distributions that have similar covariance functions or feature vectors that have large numbers of components.

Further, feature vectors that have been extracted from different data sources can be fused with each other by transforming multiple sets of feature vectors from different data sources into linear combinations of data-driven, likelihood ratio tests that achieve Bayes' error rate and generate the best linear decision boundary.

In accordance with yet another aspect of the invention, a method for measuring data distribution overlap and Bayes' error rate for two given sets of feature vectors drawn from statistical distributions that have similar covariance functions and constant or unchanging statistics involves transforming the feature vectors into a data-driven, likelihood ratio test that is the basis of an optimal linear classification system for which the eigenenergy and the Bayes' risk of the classification system are minimized, and the classification system is in statistical equilibrium. The data-driven likelihood ratio test provides a practical statistical gauge for measuring data distribution overlap and Bayes' error rate for the two given sets of feature or pattern vectors. The data-driven, likelihood ratio test can also be used to identify homogeneous data distributions.

Additional aspects, applications, and advantages will become apparent in view of the following description and associated figures.

### BRIEF DESCRIPTION OF THE DRAWINGS

FIG. 1 is a diagram illustrating how overlapping data distributions determine decision regions according to the invention.

FIG. 2 is a diagram illustrating how non-overlapping data distributions determine decision regions according to the invention.

FIG. 3 is a diagram illustrating that the decision space of a binary classification involves risks and counter risks in each of the decision regions for overlapping data distributions according to the invention.

FIG. 4 is a diagram illustrating congruent decision regions that are symmetrically partitioned by a linear decision boundary according to the invention.

FIG. 5 is a diagram illustrating congruent decision regions that are symmetrically partitioned by a linear decision boundary according to the invention.

FIG. 6 is a flowchart of one embodiment of the invention.

### DETAILED DESCRIPTION OF THE INVENTION

The present invention involves new criteria that have been devised for the binary classification problem and new geometric locus methods that have been devised and formulated within a statistical framework. Before describing the innovative concept, a new theorem for binary classification is presented along with new geometric locus methods. Geometric locus methods involve equations of curves or surfaces, where the coordinates of any given point on a curve or surface satisfy an equation, and all of the points on any given curve or surface possess a uniform characteristic or property. Geometric locus methods have important and advantageous features: locus methods enable the design of locus equations that determines curves or surfaces for which the coordinates of all of the points on a curve or surface satisfy a locus equation, and all of the points on a curve or surface possess a uniform property.

The new theorem for binary classification establishes the existence of a system of fundamental, vector-based locus equations of binary classification for a classification system in statistical equilibrium that must be satisfied by Bayes' likelihood ratio and decision boundary. Further, the new theorem provides the result that classification systems seek a point of statistical equilibrium where the opposing forces and influences of a classification system are balanced with each other, and the eigenenergy and the Bayes' risk of a classification system are minimized. The theorem and new geometric locus methods enable the design of a system of fundamental, data-driven, vector-based locus equations of binary classification for a classification system in statistical equilibrium that are satisfied by Bayes' likelihood ratio and decision boundary.

It will be appreciated by those ordinarily skilled in the art that Bayes' decision rule is the gold standard for statistical classification problems. Bayes' decision rules, which are also known as Bayes' likelihood ratio tests, divide two-class feature spaces into decision regions that have minimal conditional probabilities of classification error. Results from the prior art are outlined next.

The general form of Bayes' decision rule for a binary classification system is given by the likelihood ratio test:

$$Λ ( x ) {=}^{Δ} \text{?} {\begin{matrix}> \\ <\end{matrix}}_{{ω}_{2}} \text{?} \frac{( {C}_{12} - {C}_{22} )}{( {C}_{21} - {C}_{11} )} , \\ \text{?} \text{indicates text missing or illegible when filed}$$

where ω₁ or ω₂ is the true data category, p(x|ω₁) and p(x|ω₂) are class-conditional probability density functions, P(ω₁) and P(ω₁) are prior probabilities of the pattern classes ω₁ and ω₂, and C₁₁, C₂₁, C₂₂, and C₁₂ denote costs for four possible outcomes, where the first subscript indicates the chosen class and the second subscript indicates the true class,

Bayes' decision rule computes the likelihood ratio for a feature vector x

$$Λ ( x ) {=}^{Δ} \text{?}$$

$$\text{?} \text{indicates text missing or illegible when filed}$$

and makes a decision by comparing the ratio Λ(x) to the threshold ρ

$$η = \frac{P ( {ω}_{2} ) ( {C}_{12} - {C}_{22} )}{P ( {ω}_{1} ) ( {C}_{21} - {C}_{11} )} .$$

Costs and prior probabilities are usually based on educated guesses. Therefore, it is common practice to determine a likelihood ratio Λ(x) that is independent of costs and prior probabilities and let η be a variable threshold that accommodates changes in estimates of cost assignments and prior probabilities. Bayes' classifiers are difficult to design because the class-conditional density functions are usually not known. Instead, a collection of training data is used to estimate either decision boundaries or class-conditional density functions.

If C₁₁=C₂₂=0 and C₂₁=C₁₂=1, then the average risk [symbol] (Z) is given by the expression

$$( Z ) = P ( {ω}_{2} ) {\int }_{- ∞}^{η} p ( x \vert {ω}_{2} ) dx + P ( {ω}_{1} ) {\int }_{η}^{∞} p ( x \vert {ω}_{1} ) dx = P ( {ω}_{2} ) {\int }_{{z}_{1}}^{ } p ( x \vert {ω}_{2} ) dx + P ( {ω}_{1} ) {\int }_{{z}_{2}}^{ } p ( x \vert {ω}_{1} ) dx$$

which is the total probability of making an error, where the integral ∫_{Z}_{₂} p(x|ω₁)dx is a conditional probability given the density p(x|ω₁) and the decision region Z₂, and the integral ∫_{Z}_{₂} p(x|ω₁)dx is a conditional probability given the density p(x|ω₂) and the decision region Z₁. Accordingly, the Z₁ and Z₂ decision regions are defined to consist of values of x for which the likelihood ratio Λ(x) is, respectively, less than or greater than a threshold n, where any given set of Z₁ and Z₂ decision regions spans an entire feature space over the interval of (−∞, ∞)

The general forms of Bayes' decision rule can be written as:

$$Λ ( x ) = ln p ( x \vert {ω}_{1} ) - ln p ( x \vert {ω}_{2} ) {\begin{matrix}> \\ <\end{matrix}}_{{ω}_{2}} = p ( Λ ( x ) \vert {ω}_{1} ) - ln p ( Λ ( x ) \vert {ω}_{2} ) {\begin{matrix}> \\ <\end{matrix}}_{{ω}_{2}}$$

where P(ω₁)=P(ω₂), C₁₁=C₂₂=0 and C₂₁=C₁₂=1. For Gaussian data, Bayes' decision rule and boundary are completely defined by the likelihood ratio test:

$$Λ ( x ) = \frac{{\vert {\sum }_{2} \vert}^{1 / 2} exp \{ - \frac{1}{2} {( x - {μ}_{1} )}^{T} {\sum }_{1}^{- 1} ( x - {μ}_{1} ) \}}{{\vert {\sum }_{1} \vert}^{1 / 2} exp \{ - \frac{1}{2} {( x - {μ}_{2} )}^{T} {\sum }_{2}^{- 1} ( x - {μ}_{2} ) \}} {\begin{matrix}> \\ <\end{matrix}}_{{ω}_{2}} \text{?} \frac{( {C}_{12} - {C}_{22} )}{( {C}_{21} - {C}_{11} )} , \\ \text{?} \text{indicates text missing or illegible when filed}$$

where μ₁ and μ₂ are d-component mean vectors, Σ₁ and Σ₂ are d-by-d covariance matrices, Σ⁻¹ and |Σ| denote the inverse and determinant of a covariance matrix, and ω₁ or ω₂ is the true data category.

A new theorem for binary classification is motivated next.

An important and advantageous feature of the new theorem is that decision regions are redefined in terms of regions that are associated with decision errors or lack thereof. Accordingly, regions associated with decision errors involve regions associated with overlapping data distributions and regions associated with no decision errors involve regions associated with non-overlapping data distributions.

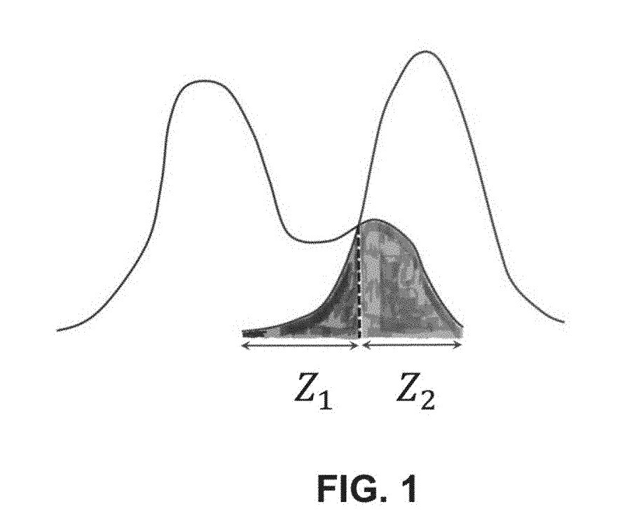

For overlapping data distributions, decision regions are defined to be those regions that span regions of data distribution overlap. Accordingly, the Z₁ decision region, which is associated with class ω₁, spans a region between the region of distribution overlap between p(x|ω₁) and p(x|ω₂) and the decision threshold n, whereas the Z₂ decision region, which is associated with class ω₂, spans a region between the decision threshold n and the region of distribution overlap between p(xx|ω₂) and p(xx|ω₁). FIG. 1 illustrates how overlapping data distributions determine decision regions.

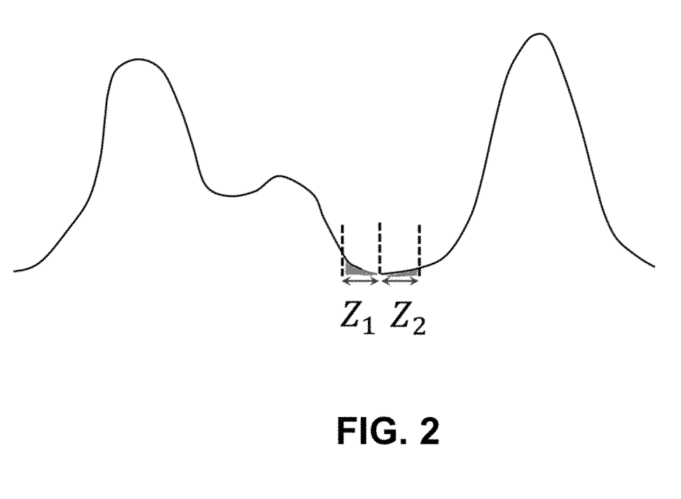

For non-overlapping data distributions, the Z₁ decision region, which is associated with class ω₁, spans a region between the tail region of p(x|ω₁) and the decision threshold η, whereas the Z₂ decision region, which is associated with class ω₂, spans a region between the decision threshold η and the tail region of p(x|ω₂). FIG. 2 illustrates how non-overlapping data distributions determine decision regions,

Take any given decision boundary D(x):Λ(x)=0 that is determined by the vector equation:

D(x):x^{T}Σ₁⁻¹μ₁−½x^{T}Σ₁⁻¹x−½μ₁^{T}Σ₁⁻¹μ₁−½In(|Σ₁|^{1/2})−x^{T}Σ₂⁻¹μ₂−½x^{T}Σ₂⁻¹x−½μ₂^{T}Σ₂⁻¹μ₁−½In(|Σ₂|^{1/2})=0 (1.1)

and is generated according to the transform of the likelihood ratio test In(Λ)(x))In(η) for

Gaussian data, where C₁₁=C₂₂=0, C₁₂=C₂₁=1, and P(ω₁)=P(ω₂)=1/2:

$$Λ ( x ) = {x}^{T} {\sum }_{1}^{- 1} {μ}_{1} - \frac{1}{2} {x}^{T} {\sum }_{1}^{- 1} x - \frac{1}{2} {μ}_{1}^{T} {\sum }_{1}^{- 1} {μ}_{1} - \frac{1}{2} ln ( {\vert {\sum }_{1} \vert}^{1 / 2} ) - {x}^{T} {\sum }_{2}^{- 1} {μ}_{2} - \frac{1}{2} {x}^{T} {\sum }_{2}^{- 1} x - \frac{1}{2} {μ}_{2}^{T} {\sum }_{2}^{- 1} {μ}_{2} - \frac{1}{2} ln ( {\vert {\sum }_{2} \vert}^{1 / 2} ) {\begin{matrix}> \\ <\end{matrix}}_{{ω}_{2}} \qquad ( 1.2 )$$

where the decision space Z and the corresponding decision regions Z₁ and Z₂ of the classification system:

$$p ( Λ ( x ) \vert {ω}_{1} ) - p ( Λ ( x ) \vert {ω}_{2} ) {\begin{matrix}> \\ <\end{matrix}}_{{ω}_{2}}$$

are determined by either overlapping or non-overlapping data distributions, and decision boundaries D(x):Λ(x)=0 are characterized by the class of hyperquadric decision surfaces which include hyperplanes, pairs of hyperplanes, hyperspheres, hyperellipsoids, hyperparaboloids, and hyperhyperboloids.

The general idea of a curve or surface which at any point of it exhibits some uniform property is expressed in geometry by the term locus. Generally speaking, a geometric locus is a curve or surface formed by points, all of which possess some uniform property. Any given geometric locus is determined by either an algebraic or a vector equation, where the locus of an algebraic or a vector equation is the location of all those points whose coordinates are solutions of the equation.

Using the general idea of a geometric locus, it follows that any given decision boundary in Eq. (1.1) that is determined by the likelihood ratio test

$$Λ ( x ) {\begin{matrix}> \\ <\end{matrix}}_{{ω}_{2}}$$

in Eq. (1.2), where me likelihood ratio Λ(x)=p(Λ(x)|ω₁)−p(Λ(x)|ω₂) and the decision boundary D)(x):Λ(x)=0 satisfy the vector equation:

p(Λ(x)|ω₁)−p(Λ(x)|ω₂)=0, (1.3)

the statistical equilibrium equation:

p(Λ(x)|ω₁)=p(Λ(x)|ω₂), (1.4)

the corresponding integral equation:

∫_{Z}p(Λ(x)|ω₁)dΛ=∫_{Z}p(Λ(x)|ω₂)dΛ (1.5)

the fundamental integral equation of binary classification:

$$f ( Λ ( x ) ) = {\int }_{{Z}_{1}}^{ } p ( Λ ( x ) \vert {ω}_{1} ) d Λ + {\int }_{{Z}_{2}}^{ } p ( Λ ( x ) \vert {ω}_{1} ) d Λ = {\int }_{{Z}_{1}}^{ } p ( Λ ( x ) \vert {ω}_{2} ) d Λ + {\int }_{{Z}_{2}}^{ } p ( Λ ( x ) \vert {ω}_{2} ) d Λ , \qquad ( 1.6 )$$

and the corresponding integral equation for a classification system in statistical equilibrium:

f(Λ(x)):∫_{Z}_{₁}p(Λ(x)|ω₁)dΛ=∫_{Z}_{₂}p(Λ(x)|ω₂)dΛ∫_{Z}_{₁}p(Λ(x)|ω₁)dΛ (1.7)

is a locus formed by all of the endpoints of pattern vectors x whose coordinates are solutions of the vector equation:

D(x):x^{T}Σ₁⁻¹μ₁−½x^{T}Σ₁⁻¹x−½μ₁^{T}Σ₁⁻¹μ₁−½In(|Σ₁|^{1/2})−x^{T}Σ₂⁻¹μ₂−½x^{T}Σ₂⁻¹x−½μ₂^{T}Σ₂⁻¹μ₁−½In(|Σ₂|^{1/2})=0,

where the endpoints of the pattern vectors x on the locus are located in regions that are either (1) associated with overlapping data distributions or (2) associated with non-overlapping data distributions,

Therefore, the equilibrium point p(Λ(x)|ω₁)−p(Λ(x)|ω₂)=0 of a classification system involves a locus of points x that jointly satisfy the likelihood ratio test in Eq. (1.2), the decision boundary in Eq. (1.1), and the system of fundamental, vector-based locus equations of binary classification for a classification system in statistical equilibrium in Eqs (1.3)-(1.7).

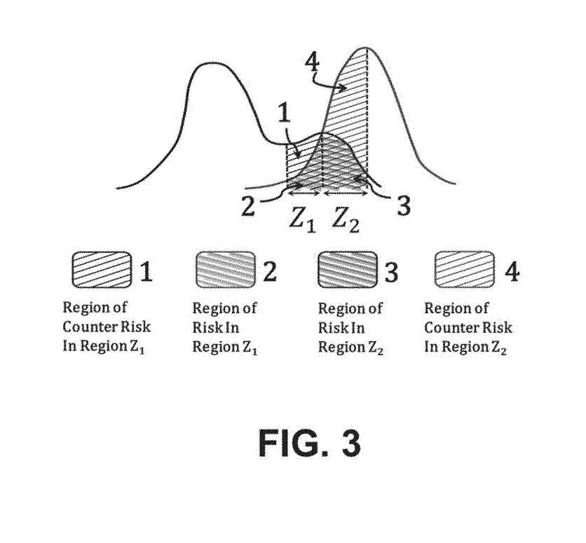

Further, Eqs (6) and (7)indicate that Bayes' risk [symbol] (Z|Λ(x)) in the decision space Z involves counter risks [symbol] (Z₁|p(Λ(x)|ω₁)) and [symbol] (Z₂|p(Λ(x)|ω₂)) associated with class ω₁ and class ω₂ in the Z₁ and Z₂ decisions regions that are opposing forces for risks [symbol] (Z₁|p(Λ(x)|ω₂)) and [symbol] (Z₂|p(Λ(x)|ω₁)) associated with class ω₂ and class ω₁ in the Z₁ and Z₂ decisions regions. FIG. 3 illustrates that the decision space of a binary classification involves risks and counter risks in each of the decision regions for overlapping data distributions. Thereby, for non-overlapping data distributions, any given decision space is determined by counter risks.

Vector-based locus equations have been devised for all of the conic sections and quadratic surfaces: lines, planes, and hyperplanes; d-dimensional parabolas, hyperbolas, and ellipses; and circles and d-dimensional spheres. The form of each vector-based locus equation hinges on both the geometric property and the frame of reference (the coordinate system) of the locus. Moreover, the locus of a point is defined in terms of the locus of a vector. A position vector x is defined to be the locus of a directed, straight line segment formed by two points P₀ and Pₓ which are at a distance of

∥x∥=(x₁²+x₂²+ . . .

from each other, where ∥x∥ denotes the length of a position vector x, such that each point coordinate or vector component xᵢ is at a signed distance of ∥x∥cos αᵢⱼ from the origin P₀, along the direction of an orthonormal coordinate axis , where cos αᵢⱼ is the direction cosine between the vector component xᵢ and the orthonormal coordinate axis eⱼ. Accordingly, a point is the endpoint on the locus of a position vector. Points and vectors are both denoted by x, and the locus of any given vector x is based on the above definition.

The vector-based locus equations have been used to identify important and advantageous features of conic sections and quadratic surfaces:

The uniform properties exhibited by all of the points x on any given linear locus are specified by the locus of its principal eigenaxis v, where each point x on the linear locus and the principal eigenaxis v of the linear locus satisfy the linear locus in terms of the eigenenergy ∥v∥² exhibited by its principal eigenaxis v. Accordingly, the vector components of a principal eigenaxis specify all forms of lines, planes, and hyperplanes, and all of the points x on any given linear curve or surface explicitly and exclusively reference the principal eigenaxis v of the linear locus. Therefore, the important generalizations and properties for a linear locus are specified by the eigenenergy exhibited by the locus of its principal eigenaxis, and the principal eigenaxis of a linear locus provides an elegant, general eigen-coordinate system for a linear locus of points.

The uniform properties exhibited by all of the points x on any given quadratic locus are specified by the locus of its principal eigenaxis v, where each point x on the quadratic locus and the principal eigenaxis v of the quadratic locus satisfy the quadratic locus in terms of the eigenenergy ∥v∥² exhibited by its principal eigenaxis v. Accordingly, the vector components of a principal eigenaxis specify all forms of quadratic curves and surfaces, and all of the points x on any given quadratic curve or surface explicitly and exclusively reference the principal eigenaxis v of the quadratic locus. Therefore, the important generalizations and properties for a quadratic locus are specified by the eigenenergy exhibited by the locus of its principal eigenaxis, and the principal eigenaxis of a quadratic locus provides an elegant, general eigen-coordinate system for a quadratic locus of points.

In summary, the vector-based locus equations of conic sections and quadratic surfaces determine an elegant, general eigen-coordinate system for each class of conic sections and quadratic surfaces and a uniform property that is exhibited by all of the points on any given conic section or quadratic surface. Moreover, the vector-based locus equations establish that the locus of points x that satisfies the decision boundary D(x):Λ(x)=0 in Eq. (1.1) must involve a locus of principal eigenaxis components that satisfies the decision boundary D(x) in terms of a total allowed eigenenergy.

Take the system of fundamental locus equations of binary classification for a classification system in statistical equilibrium that must be satisfied by Bayes' likelihood ratio:

Λ(x)=p(Λ(x)|ω₁)−p(Λ(x)|ω₂)

and decision boundary:

D(x):p(Λ(x)|ω₁)−p(Λ(x)|ω₂)=0,

where the decision boundary D(x):Λ(x)=0 and the likelihood ratio Λ(x) satisfy Eqs (1.3)-(1.7).

Given that the locus of a conic section or a quadratic surface is determined by the locus of its principal eigenaxis, it follows that the vector-based locus equation in Eq. (1.3)

p(Λ(x)|ω₁)−p(Λ(x)|ω₂)=0,

that is satisfied by the likelihood ratio Λ(x) and the decision boundary 1)(x):Λ(x)=0 must involve a parameter vector of likelihoods and a corresponding locus of principal eigenaxis components that delineates a decision boundary. Furthermore, the locus of principal eigenaxis components must satisfy the decision boundary D(x):Λ(x)=0 in terms of a total allowed eigenenergy, where the total allowed eigenenergy of a classification system is the eigenenergy associated with the position or location of the likelihood ratio Λ(x)=p(Λ(x)|ω₁)−p(Λ(x)|ω₂) and the locus of a corresponding decision boundary D(x):pΛ(x)=p(Λ(x)|ω₁)−p(Λ(x)|ω₂)=0.

The new theorem for binary classification can be stated as follows.

Let

$$p ( Λ ( x ) \vert {ω}_{1} ) - p ( Λ ( x ) \vert {ω}_{2} ) {\begin{matrix}> \\ <\end{matrix}}_{{ω}_{2}}$$

denote the likelihood ratio test for a binary classification system, where ω₁ or ω₂ is the true data category, and d-component random vectors x from class ω₁ and class ω₂ are generated according to probability density functions p(x|ω₁) and p(x|ω₂) related to statistical distributions of random vectors x that have constant or unchanging statistics.

The discriminant function

Λ(x)=p(Λ(x)|ω₁)−p(Λ(x)|ω₂)

is the solution to the integral equation

$$f ( Λ ( x ) ) = {\int }_{{Z}_{1}}^{ } p ( Λ ( x ) \vert {ω}_{1} ) d Λ + {\int }_{{Z}_{2}}^{ } p ( Λ ( x ) \vert {ω}_{1} ) d Λ = {\int }_{{Z}_{1}}^{ } p ( Λ ( x ) \vert {ω}_{2} ) d Λ + {\int }_{{Z}_{2}}^{ } p ( Λ ( x ) \vert {ω}_{2} ) d Λ ,$$

over the decision space Z=Z₁+Z₂, such that the Bayes' risk [symbol] (Z|Λ(x)) and the corresponding eigenenergy Eₘᵢₙ(Z|Λ(x) of the classification system

$$p ( Λ ( x ) \vert {ω}_{1} ) - p ( Λ ( x ) \vert {ω}_{2} ) {≷}_{{ω}_{2}}$$

are governed by the equilibrium point)

p(Λ(x)|ω₁)−p(Λ(x)|ω₂)=0

of the integral equation f(Λ(x)).

Therefore, the forces associated with Bayes' counter risk [symbol] (Z₁|p(Λ(x)|ω₁)) and Bayes' risk [symbol] (Z₂|p(Λ(x)|ω₁)) in the Z₁ and Z₂ decision regions, which are related to positions and potential locations of random vectors x that are generated according to p(Λ(x)|ω₁), are equal to the forces associated with Bayes' risk [symbol] (Z₁|p(Λ(x)|ω₂)) and Bayes' counter risk [symbol] (Z₂|p(Λ(x)|ω₂)) in the Z₁ and Z₂ decision regions, which are related to positions and potential locations of random vectors x that are generated according to p(x|ω₂).

Furthermore, the eigenenergy Eₘᵢₙ(Z|p(Λ(x)|ω₁)) associated with the position or location of the likelihood ratio p(Λ(x)|ω₁) given class ω₁ is equal to the eigenenergy) Eₘᵢₙ(Z|p(Λ(x)|ω₂)) associated with the position or location of the likelihood ratio p(Λ(x)|ω₂) given class ω₂:

Eₘᵢₙ(Z|p(Λ(x)|ω₁))=Eₘᵢₙ(Z|p(Λ(x)|ω₂)).

Thus, the total eigenenergy Eₘᵢₙ(Z|Λ(x)) of the binary classification system

$$p ( Λ ( x ) \vert {ω}_{1} ) - p ( Λ ( x ) \vert {ω}_{2} ) {≷}_{{ω}_{2}}$$

is equal to the eigenenergies associated with the position or location of the likelihood ratio p(Λ(x)|ω₁)−p(Λ(x)|ω₂) and the locus of a corresponding decision boundary D(x): p(Λ(x)|ω₁)−p(Λ(x)|ω₂)=0:

Eₘᵢₙ(Z|p(Λ(x))=Eₘᵢₙ(Z|p(Λ(x)|ω₁)+i Eₘᵢₙ(Z|p(Λ(x)|ω₂)).

It follows that the binary classification system

$$p ( Λ ( x ) \vert {ω}_{1} ) - p ( Λ ( x ) \vert {ω}_{2} ) {≷}_{{ω}_{2}}$$

is in statistical equilibrium:

f(Λ(x)):∫_{Z}_{₁}p(Λ(x)|ω₁)dΛ−∫_{Z}_{₁}p(Λ(x)|ω₂)dΛ=∫_{Z}_{₁}p(Λ(x)|ω₂)dΛ−∫_{Z}_{₂}p(Λ(x)|ω₁)dΛ,

where the forces associated with Bayes' counter risk [symbol] (Z₁|p(Λ(x)|ω₁)) for class ω₁ and Bayes' risk [symbol] (Z₁|p(Λ(x)|ω₂)) for class ω₂ in the Z₁ decision region are balanced with the forces associated with Bayes' counter risk [symbol] (Z₂|p(Λ(x)|ω₂)) for class ω_{2 2} and Bayes' risk [symbol] (Z₂|p(Λ(x)|ω₁)) for class ω₁ in the Z₂ decision region such that the Bayes' risk [symbol] (Z|Λ(x)) of the classification system is minimized, and the eigenenergies associated with Bayes' counter risk [symbol] (Z₁|p(Λ(x)|ω₁)) for class ω₁ and Bayes' risk [symbol] (Z₁|p(Λ(x)|ω₂)) for class ω₂ in the Z₁ decision region are balanced with the eigenenergies associated with Bayes' counter risk [symbol] (Z₂|p(Λ(x)|ω₂)) for class ω₂ and Bayes' risk [symbol] (Z₂|p(Λ(x)|ω₁)) for class ω₁ in the Z₂ decision region such that the eigenenergy Eₘᵢₙ(Z|Λ(x)) of the classification system is minimized. Thus, any given binary classification system

$$p ( Λ ( x ) \vert {ω}_{1} ) - p ( Λ ( x ) \vert {ω}_{2} ) {≷}_{{ω}_{2}}$$

exhibits an error rate that is consistent with the Bayes'risk [symbol] (Z|Λ(x)) and the corresponding eigenenergy Eₘᵢₙ(Z|Λ(x)) of the classification system: for all random vectors x that are generated according to p(x|ω₁) and p(x|ω₂), where p(x|ω₁) and p(x|ω₂) are related to statistical distributions of random vectors x that have constant or unchanging statistics.

Therefore, the Bayes' risk [symbol] (Z|Λ(x) and the corresponding eigenenergy Eₘᵢₙ(Z|Λ(x)) of the classification system

$$p ( Λ ( x ) \vert {ω}_{1} ) - p ( Λ ( x ) \vert {ω}_{2} ) {≷}_{{ω}_{2}}$$

are governed by the equilibrium point

p(Λ(x)|ω₁)−p(Λ(x)|ω₂)=0

of the integral equation

$$f ( Λ ( x ) ) = {\int }_{{Z}_{1}}^{ } p ( Λ ( x ) \vert {ω}_{1} ) d Λ + {\int }_{{Z}_{2}}^{ } p ( Λ ( x ) \vert {ω}_{1} ) d Λ = {\int }_{{Z}_{1}}^{ } p ( Λ ( x ) \vert {ω}_{2} ) d Λ + {\int }_{{Z}_{2}}^{ } p ( Λ ( x ) \vert {ω}_{2} ) d Λ ,$$

over the decision space Z=Z₁+Z₂, where the opposing forces and influences of the classification system are balanced with each other, such that the eigenenergy and the Bayes' risk of the classification system are minimized, and the classification system is in statistical equilibrium,

Moreover, the eigenenergy Eₘᵢₙ(Z|Λ(x)) is the state of a binary classification system

$$p ( Λ ( x ) \vert {ω}_{1} ) - p ( Λ ( x ) \vert {ω}_{2} ) {≷}_{{ω}_{2}}$$

that is associated with the position or location of a likelihood ratio in statistical equilibrium: p(Λ(x)|ω₁)−p(Λ(x)|ω₂)=0 and the locus of a corresponding decision boundary: D(x): p(Λ(x)|ω₁)−p(Λ(x)|ω₂)=0.

The binary classification theorem that is outlined above has unique, important, and advantageous features. The theorem establishes new and essential criteria for the binary classification problem: which is the fundamental technical problem that underlies all automated decision making and statistical pattern recognition applications. The theorem establishes the existence of a system of fundamental, vector-based, locus equations of binary classification for a classification system in statistical equilibrium that must be satisfied by Bayes' likelihood ratio and decision boundary. Further, the theorem provides the result that any given binary classification system seeks a point of statistical equilibrium where the opposing forces and influences of the classification system are balanced with each other, so that the eigenenergy and the Bayes' risk of the classification system are minimized, and the classification system is in statistical equilibrium,

Moreover, given that new geometric locus methods establish that the vector components of a principal eigenaxis specify all forms of conic curves and quadratic surfaces, such that all of the points on any given conic curve or quadratic surface explicitly and exclusively reference the principal eigenaxis of the conic section or quadratic surface, and that the principal eigenaxis and all of the points of any given conic section or quadratic surface satisfy the eigenenergy exhibited by its principal eigenaxis, it follows that the locus of points x that satisfies the decision boundary D(x): Λ(x)=0 in Eq. (1.1) must involve a locus of principal eigenaxis components that satisfies the decision boundary D(x): Λ(x)=0 in terms of a critical minimum or total allowed eigenenergy.

Therefore, the system of fundamental locus equations of binary classification for a classification system in statistical equilibrium that must be satisfied by Bayes' likelihood ratio Λ(x) and decision boundary D(x):Λ(x)=0 involves a dual locus of likelihoods and principal eigenaxis components: i.e., a parameter vector of likelihoods that satisfies a decision boundary in terms of a minimum amount of risk and a corresponding locus of principal eigenaxis components that satisfies a decision boundary in terms of a critical minimum eigenenergy. Moreover, because the decision space Z=Z₁+Z₂ of a binary classification system is determined by decision regions Z₁ and Z₂ that are associated with either overlapping regions or tail regions between two data distributions, the dual locus of likelihoods and principal eigenaxis components must be formed by feature vectors that lie in either overlapping regions or tail regions between two data distributions. Feature vectors that lie in either overlapping regions or tail regions between two data distributions are called extreme points. Extreme points are fundamental components of computer-implemented binary classification systems. Properties of extreme points are outlined next.

Take a collection of feature vectors for any two pattern classes drawn from any two statistical distributions, where the data distributions are either overlapping or non-overlapping with each other. An extreme point is defined to be a data point which exhibits a high variability of geometric location, that is, possesses a large covariance, such that it is located (1) relatively far from its distribution mean, (2) relatively close to the mean of the other distribution, and (3) relatively close to other extreme points. Therefore, an extreme point is located somewhere within either an overlapping region or a tail region between the two data distributions. Given the geometric and statistical properties exhibited by the locus of an extreme point, it follows that a set of extreme vectors determine principal directions of large covariance for a given collection of training data. Thus, extreme vectors are discrete principal components that specify directions for which a given collection of training data is most variable or spread out. Any given extreme point is characterized by an expected value (a central location) and a covariance (a spread). Thereby, distributions of extreme points determine decision regions for binary classification systems, where the forces associated with Bayes' risks and Bayes' counter risks are related to positions and potential locations of extreme data points.

The innovative concept is outlined next. The innovative concept involves a system of fundamental, data-driven, vector-based locus equations of binary classification for a linear classification system in statistical equilibrium that generates a data-driven likelihood ratio test that contains Bayes' likelihood ratio and automatically generates the best linear decision boundary. The data-driven likelihood ratio test, which is based on a dual locus of likelihoods and principal eigenaxis components formed by a locus of weighted extreme points, satisfies fundamental statistical laws for a binary classification system in statistical equilibrium and is the basis of a linear classification system for which the eigenenergy and the Bayes' risk are minimized, so that the opposing forces and influences of the classification system are balanced with each other, and the classification system achieves Bayes' error rate: for feature vectors drawn from statistical distributions that have similar covariance functions,

A dual locus of likelihoods and principal eigenaxis components formed by a locus of weighted extreme points is a locus of principal eigenaxis components that delineates the best linear decision boundary as well as a parameter vector of likelihoods of extreme points that satisfies the linear decision boundary in terms of a minimum amount of risk. Any given dual locus of likelihoods and principal eigenaxis components has the following unique and advantageous features.

The dual locus of likelihoods and principal eigenaxis components satisfies a data-driven version of the system of fundamental locus equations of binary classification for a classification system in statistical equilibrium in Eqs (1.3)-(1.7).

The dual locus of principal eigenaxis components provides an elegant, statistical eigen-coordinate system for a linear classification system. Further, the dual locus of principal eigenaxis components satisfies a critical minimum, i.e., a total allowed, eigenenergy constraint, so that the locus of principal eigenaxis components satisfies a linear decision boundary in terms of its critical minimum or total allowed eigenenergies.

The dual locus of likelihoods and principal eigenaxis components is formed by extreme points, i.e., extreme feature vectors or extreme pattern vectors, that lie in either overlapping regions or tail regions between two data distributions, thereby determining decision regions based on forces associated with Bayes' risks and Bayes' counter risks: which are related to positions and potential locations of the extreme points, where an unknown portion of the extreme points are the source of Bayes' decision error.

The dual locus of likelihoods and principal eigenaxis components is the basis of a linear classification system for which the eigenenergy and the Bayes' risk are minimized, so that the opposing forces and influences of the classification system are balanced with each other, and the classification system achieves Bayes' error rate: for feature vectors drawn from statistical distributions that have similar covariance functions.

The dual locus of likelihoods and principal eigenaxis components is a parameter vector of likelihoods of extreme points that contains Bayes' likelihood ratio.

The inventor has named a dual locus of likelihoods and principal eigenaxis components formed by weighted extreme points a “linear eigenlocus.” The inventor has named the related parameter vector that provides an estimate of class-conditional densities for extreme points a “locus of likelihoods,” The inventor has named the system of fundamental, data-driven, vector-based locus equations of binary classification for a classification system in statistical equilibrium that generates a linear eigenlocus a “linear eigenlocus transform.”

Linear eigenlocus transforms generate a locus of weighted extreme points that is a dual locus of likelihoods and principal eigenaxis components, where each weight specifies a class membership statistic and conditional density for an extreme point and each weight determines the magnitude and the total allowed eigenenergy of an extreme vector,

Linear eigenlocus transforms generate a set of weights that satisfy the following criteria:

Criterion 1: Each conditional density of an extreme point describes the central location (expected value) and the spread (covariance) of the extreme point.

Criterion 2: Distributions of the extreme points are distributed over the locus of likelihoods in a symmetrically balanced and well-proportioned manner.

Criterion 3: The total allowed eigenenergy possessed by each weighted extreme vector specifies the probability of observing the extreme point within a localized region.

Criterion 4: The total allowed eigenenergies of the weighted extreme vectors are symmetrically balanced with each other about the center of total allowed eigenenergy.

Criterion 5: The forces associated with Bayes' risks and Bayes' counter risks related to the weighted extreme points are symmetrically balanced with each other about the center of Bayes' risk.

Criterion 6: The locus of principal eigenaxis components formed by weighted extreme vectors partitions any given feature space into congruent decision regions which are symmetrically partitioned by a linear decision boundary.

Criterion 7: The locus of principal eigenaxis components is the focus of a linear decision boundary.

Criterion 8: The locus of principal eigenaxis components formed by weighted extreme vectors satisfies the linear decision boundary in terms of a critical minimum eigenenergy.

Criterion 9: The locus of likelihoods formed by weighted extreme points satisfies the linear decision boundary in terms of a minimum probability of decision error.

Criterion 10: For data distributions that have dissimilar covariance matrices, the forces associated with Bayes' counter risks and Bayes' risks, within each of the congruent decision regions, are balanced with each other. For data distributions that have similar covariance matrices, the forces associated with Bayes' counter risks within each of the congruent decision regions are equal to each other, and the forces associated with Bayes' risks within each of the congruent decision regions are equal to each other.

Criterion 11: For data distributions that have dissimilar covariance matrices, the eigenenergies associated with Bayes' counter risks and the eigenenergies associated with Bayes' risks, within each of the congruent decision regions, are balanced with other. For data distributions that have similar covariance matrices, the eigenenergies associated with Bayes' counter risks within each of the congruent decision regions are equal to each other, and the eigenenergies associated with Bayes' risks within each of the congruent decision regions are equal to each other.

The system of data-driven, locus equations that generates likelihood ratios and decision boundaries satisfies all of the above criteria. The set of criteria involve a unique and advantageous statistical property that the inventor has named “symmetrical balance.” This unique and advantageous feature ensures that learning machines generated by linear eigenlocus transforms exhibit optimal generalization performance and have the highest possible accuracy: for feature vectors drawn from statistical distributions that have similar covariance functions.

Symmetrical balance can be described as having an even distribution of “weight” or a similar “load” on equal sides of a centrally placed fulcrum. As a practical example, consider the general machinery of a fulcrum and a lever, where a lever is any rigid object capable of turning about some fixed point called a fulcrum. If a fulcrum is placed under directly under a lever's center of gravity, the lever will remain balanced. Accordingly, the center of gravity is the point at which the entire weight of a lever is considered to be concentrated, so that if a fulcrum is placed at this point, the lever will remain in equilibrium. If a lever is of uniform dimensions and density, then the center of gravity is at the geometric center of the lever. For example, consider the playground device known as a seesaw or teeter-totter. The center of gravity is at the geometric center of a teeter-totter, which is where the fulcrum of a seesaw is located. Accordingly, the physical property of symmetrical balance involves a physical system in equilibrium, whereby the opposing forces or influences of the system are balanced with each other.

The statistical property of symmetrical balance involves a data-driven, binary classification system in statistical equilibrium, whereby the opposing forces or influences of the classification system are balanced with each other, and the eigenenergy and Bayes' risk of the classification system are minimized. Linear eigenlocus transforms generate a data-driven likelihood ration test that is based on a dual locus of principal eigenaxis components and likelihoods, formed by a locus of weighted extreme points, all of which exhibit the statistical property of symmetrical balance. The dual locus provides an estimate of a principal eigenaxis that has symmetrically balanced distributions of eigenenergies on equal sides of a centrally placed fulcrum, which is located at its center of total allowed eigenenergy. The dual locus also provides an estimate of a parameter vector of likelihoods that has symmetrically balanced distributions of forces associated with Bayes' risks and Bayes' counter risks on equal sides of a centrally placed fulcrum, which is located at the center of Bayes' risk. Thereby, a dual locus of principal eigenaxis components and likelihoods is in statistical equilibrium.

Linear eigenlocus transforms involve solving an inequality constrained optimization problem.

Take any given collection of training data for a binary classification problem of the form:

$$( {x}_{1} , {y}_{1} ) , \text{?} … , \} , \\ \text{?} \text{indicates text missing or illegible when filed}$$

where feature vectors x from class ω₁ and class ω₂ are drawn from unknown, class-conditional probability density functions p(x|ω₁) and p(x|ω₂) and are identically distributed. Feature vectors x can be extracted from any given source of digital data: i.e., digital images, digital videos, digital signals, or digital waveforms, and are labeled.

A linear eigenlocus τ is estimated by solving an inequality constrained optimization problem:

minΨ(τ)=∥τ∥²/2+C/2Σᵢ₌₁^{N}ξᵢ², s.t. yᵢ(xᵢ^{T}τ+τ₀)≥1−ξᵢ, ξᵢ≥0,i=1, (1.8)

where τ is a d×1 constrained, primal linear eigenlocus which is a dual locus of likelihoods and principal eigenaxis components, ∥τ∥² is the total allowed eigenenergy exhibited by τ, τT₀ is a functional of τ, C and ξᵢ are regularization parameters, and yᵢ are class membership statistics: if xᵢϵω₁, assign yᵢ=+1; if xᵢϵω₂, assign yᵢ=−1.

Equation (1.8) is the primal problem of a linear eigenlocus, where the system of N inequalities must be satisfied:

yᵢ(xᵢ^{T}τ+τ₀)≥1−ϵᵢ, ϵᵢ≥0,=1,

such that τ satisfies a critical minimum eigenenergy constraint:

y(τ)=∥τ∥ₘᵢₙ_{_{c}}², (1.9)

where the total allowed eigenenergy ∥τ∥ₘᵢₙ_{_{c}}² exhibited by τ determines the Bayes' risk [symbol] (Z|τ) of a linear classification system.

Solving the inequality constrained optimization problem in Eq. (1.8) involves solving a dual optimization problem that determines the fundamental unknowns of Eq. (1.8). Denote a Wolfe dual linear eigenlocus by Ψ, and the Lagrangian dual problem of Ψ by max Ξ(Ψ). Let Ψ be a Wolfe dual of κ such that proper and effective strong duality relationships exist between the algebraic systems of min Ψ(τ) and max Ξ(Ψ). Thereby, let Ψ be related with τ in a symmetrical manner that specifies the locations of the principal eigenaxis components on τ.

For the problem of linear eigenlocus transforms, the Lagrange multipliers method introduces a Wolfe dual linear eigenlocus Ψ of principal eigenaxis components, for which the Lagrange multipliers {Ψᵢ}ᵢ₌₁^{N} are the magnitudes or lengths of a set of Wolfe dual principal eigenaxis components

$${\{ {ψ}_{i} {\vec{e}}_{i} \}}_{i = 1} ,$$

where

$${\{ {\vec{e}}_{i} \}}_{i = 1}$$

are non-orthogonal unit vectors and finds extrema for the restriction of τ to a Wolfe dual eigenspace. The fundamental unknowns associated with Eq. (1.8) are the magnitudes or lengths of the Wolfe dual principal eigenaxis components on Ψ: scale factors of the principal eigenaxis components on Ψ. Each scale factor specifies a conditional density for a weighted extreme point on a locus of likelihoods, and each scale factor determines the magnitude and the eigenenergy of a weighted extreme vector on a locus of principal eigenaxis components.

The inequality constrained optimization problem in Eq. (1.8) is solved by using Lagrange multipliers Ψᵢ≥0 and the Lagrangian:

L_{Ψ(τ)}(τ, τ₀, ξ, Ψ)=∥τ∥²/2+C/2Σᵢ₌₁^{N}ξᵢ²−Σᵢ₌₁^{N}Ψᵢ{yᵢ(xᵢ^{T}τ+τ₀)−1+ξᵢ} (1.10)

which is minimized with respect to the primal variables τ and τ₀ and is maximized with respect to the dual variables Ψᵢ.

The Karush-Kuhn-Tucker (KKT) conditions on the Lagrangian L_{Ψ(τ)}:

τ−Σᵢ₌₁^{N}Ψᵢyᵢxᵢ=0, i=1, (1.11)

Σᵢ₌₁^{N}Ψᵢyᵢ=0, i=1, (1.12)

CΣᵢ₌₁^{N}ξᵢ−Σᵢ₌₁^{N}Ψᵢ=0, i=1, (1.13)

Ψᵢ≥0, i=1, (1.14)

Ψᵢ[yᵢ(xᵢ^{T}τ+τ₀)−1+ξᵢ]≥0, i=1 (1.15)

determine a system of fundamental, data-driven locus equations of binary classification for a linear classification system in statistical equilibrium that are jointly satisfied by τ and Ψ. The system of locus equations is a data-driven version of Eqs (1.3)-(1.7).

The resulting expressions for τ in Eq. (1.11) and Ψ in Eq. (1.12) are substituted into the Lagrangian functional L_{Ψ(κ)} of Eq. (1.10) and simplified. This produces the Lagrangian dual problem:

$$max Ξ ( Ψ ) = {\sum }_{i = 1}^{N} {ψ}_{i} - {\sum }_{i , j = 1}^{N} {ψ}_{i} {ψ}_{j} {y}_{i} {y}_{j} \frac{{x}_{i}^{T} {x}_{j} + {δ}_{ij} \text{/} C}{2} \qquad ( 1.16 )$$

which is subject to the algebraic constraints Σᵢ₌₁^{N}Ψᵢyᵢ=0, and Ψᵢ≥0, where δᵢⱼ is the Kronecker δ defined as unity for i=j and 0 otherwise.

Equation (1.16) is a quadratic programming problem that can be written in vector notation by letting

$$Q {=}^{Δ} \text{?} and X {=}^{Δ} \text{?} , \\ \text{?} \text{indicates text missing or illegible when filed}$$

where D is an N×N diagonal matrix of training labels (class membership statistics) y, and the N×d data matrix is

$$X = ( {x}_{1} , {x}_{2} , … \text{?} \\ \text{?} \text{indicates text missing or illegible when filed}$$

This produces the matrix version of the Lagrangian dual problem:

$$max Ξ ( Ψ ) = {1}^{T} Ψ - \frac{{Ψ}^{T} Q Ψ}{2} \qquad ( 1.17 )$$

which is subject to the constraints Ψ^{T}y=0 and Ψᵢ≥0. Given the theorem for convex duality, it follows that Ψ is a dual locus of likelihoods and principal eigenaxis components, where Ψ exhibits a total allowed eigenenergy ∥Ψ∥ₘᵢₙ_{_{c}}² that is symmetrically related to the total allowed eigenenergy ∥τ∥ₘᵢₙ_{_{c}}² of τ: ∥Ψ∥ₘᵢₙ_{_{c}}²=τ

Using the KKT conditions in Eqs (1.11) and (1.14), it follows that τ satisfies the following locus equation:

τ=Σᵢ₌₁^{N}yᵢΨᵢxᵢ, (1.18)

where the yᵢ terms are class membership statistics (if xᵢ is a member of class ω₁, assign yᵢ=+1; otherwise, assign yᵢ=−1) and the magnitude Ψᵢ of each principal eigenaxis component Ψᵢ\vec{e}ᵢ on Ψ is greater than or equal to zero: Ψᵢ≥0. Data points xᵢ correlated with Wolfe dual principal eigenaxis components Ψᵢ\vec{e}ᵢ that have non-zero magnitudes Ψᵢ>0 are termed extreme vectors.

All of the principal eigenaxis components on ti are labeled extreme points in [symbol] Denote the labeled, scaled extreme vectors that belong to class ω₁ and ω₂ by Ψ_{1i*}x_{1i*} and −Ψ_{2i*}x_{2i*}, with scale factors: Ψ_{1i*} and Ψ_{2i*}, extreme vectors: x_{1i*} and x_{2i*}, and labels: yᵢ=+1 and yᵢ=−1 respectively. Let there be lᵢ labeled, scaled extreme vectors {Ψ_{1i*}x_{1i*}}ᵢ₋₁^{l}^{₁} and l₂ labeled, scaled extreme vectors {Ψ_{2i*}x_{2i*}}ᵢ₋₁^{l}^{₂}.

Given Eq. (1.18) and the assumptions outlined above, it follows that τ is based on the vector difference between a pair of components:

$$\begin{matrix}τ = {τ}_{1} - {τ}_{2} \\ = {\sum }_{i = 1}^{{l}_{i}} {ψ}_{1 {i}^{*}} {x}_{1 {i}^{*}} - {\sum }_{i = 1}^{{l}_{2}} {ψ}_{2 {i}^{*}} {x}_{2 {i}^{*}} ,\end{matrix} \qquad ( 1.19 )$$

where the components τ₁=Σᵢ₌₁^{l}^{₁}Ψ_{1i*}x_{1i*} and τ₂=Σᵢ₌₁^{l}^{₂}Ψ_{2i*}x_{2i*} are denoted by are denoted by τ₁ and τ₂ respectively. The scaled extreme points on τ₁ and τ₂ determine the loci of τ₁ and τ₂ and therefore determine the dual locus of τ=τ₁−τ₂.

The number and the locations of the principal eigenaxis components on Ψ and τ are considerably affected by the rank and eigenspectrum of the Gram matrix Q. Low rank Gram matrices Q generate “weak dual” linear eigenlocus transforms that produce irregular, linear partitions of decision spaces. These problems are solved by the regularization method that is described next.

For any collection of N training vectors of dimension d, where d<N, the Gram matrix Q has low rank. The regularized form of Q, for which ϵ<< and

$$Q {=}^{Δ} \text{?} , \\ \text{?} \text{indicates text missing or illegible when filed}$$

ensures that Q has full rank and a complete eigenvector set: so that Q has a complete eigenspectrum. The regularization constant C is related to the regularization parameter ϵ by (1C).

For N training vectors of dimension d, where d<N, all of the regularization parameters {ξᵢ}ᵢ₌₁^{N} in Eq. (1.8) and all of its derivatives are set equal to a very small value: ξᵢ=ξ<<. The regularization constant C is set equal to

$$\frac{1}{ξ} : C = \frac{1}{ξ} .$$

For N training vectors of dimension d, where N<d, all of the regularization parameters {ξᵢ}ᵢ₌₁^{N} in Eq. (1.8) and all of its derivatives are set equal to zero: ξᵢ=ξ=0. The regularization constant C is set equal to infinity: C=∞.

A primal linear eigenlocus τ=τ₁−τ₂ is the primary basis of a linear discriminant function D(x)=τ^{T}x+τ₀. A constrained, linear discriminant function D(x)=τ^{T}x+τ₀, where D(x)=0 , D(x)+1, and D(x)=1, determines a linear classification system

$${τ}^{T} x + {τ}_{0} {≷}_{{ω}_{2}} ,$$

where τ=τ₁−τ₂ is the likelihood ratio of the classification system.

A linear eigenlocus test

$${τ}^{T} x + {τ}_{0} {≷}_{{ω}_{2}}$$

generates a decision boundary that divides a feature space Z into congruent decision regions Z₁ and Z₂. The manner in which a linear eigenlocus test partitions a feature space is specified by the KKT condition in Eq. (1.15) and the KKT condition of complementary slackness, The KKT condition of complementary slackness requires that for all constraints that are not active in Eq. (1.15), where locus equations are ill-defined:

yᵢ(xᵢ^{T}τ+τ₀)−1+ξᵢ>0

because they are not satisfied as equalities, the corresponding magnitudes Ψᵢ of the Wolf dual principal eigenaxis components Ψᵢ\vec{e}ᵢ on Ψ must be zero: Ψᵢ=0. Accordingly, if an inequality is “slack” (not strict), the other inequality cannot be slack.

Therefore, let there be l active constraints, where l=l₁+l₂, and let ξᵢ=ξ=0 or ξᵢ=ξ<<. The theorem of Karush, Kuhn, and Tucker provides the guarantee that a Wolf dual linear eigenlocus Ψ exists such that the following constraints are satisfied:

{ω_{i*}>0}ᵢ₌₁^{l}

and the following locus equations are satisfied:

Ψ_{i*}[yᵢ(x_{i*}^{T}τ+τ₀)−1+ξᵢ]=0, i=1,

where l Wolfe dual principal eigenaxis components Ψ_{i*}\vec{e}ᵢ have non-zero magnitudes {Ψᵢ\vec{e}ᵢ|Ψ_{i*} [symbol] υ}ᵢ₌₁^{l}.

Accordingly, let there be l₁ locus equations:

x_{1*}^{T}τ+τ₀+ξᵢ=1, i=1,

where yᵢ=+1, and l₂ locus equations:

x_{1*}^{T}τ+τ₀−ξᵢ=−1, i=1,

where yᵢ=−1.
It follows that the linear discriminant function

D(x)=τ^{T}x+τ₀ (1.20)

satisfies the set of constraints.

D₀(x)=0, D₊₁(x)=+1, and D₋₁(x)=−1

where D₀(x)=0 denotes a linear decision boundary, D₊₁(x) denotes a linear decision border for the Z₁ decision region, and D_{—1} (x) denotes a linear decision border for the Z₂ decision region.

Given the assumption that D(x)=0 , the linear discriminant function in Eq. (1.20) can be rewritten as:

$$\frac{{x}^{T} τ}{‖ τ ‖} = - \frac{{τ}_{0}}{‖ τ ‖} , \qquad ( 1.21 )$$

where

$$\frac{\vert {τ}_{0} \vert}{‖ τ ‖}$$

is the distance of a linear decision boundary to the origin. Any point x that satisfies Eq. (1.21) is on the linear decision boundary D₀(x), and all of the points x on the linear decision boundary D₀(x) exclusively reference τ. Thereby, the constrained, linear discriminant function τ^{T}x+τ₀ satisfies the boundary value of a linear decision boundary D₀(x):τ^{T}x+τ₀=0.

Given the assumption that D(x)=1, the linear discriminant function in Eq. (1.20) can be rewritten as:

$$\frac{{x}^{T} τ}{‖ τ ‖} = \frac{{τ}_{0}}{‖ τ ‖} + \frac{1}{‖ τ ‖} , \qquad ( 1.22 )$$

where

$$\frac{\vert 1 - {τ}_{0} \vert}{‖ τ ‖}$$

is the distance of the linear decision border to the origin. Any point x that satisfies Eq. (1.22) is on the linear decision border D₊₁(x), and all of the points x on the linear decision border D₊₁(x)) exclusively reference τ. Thereby, the constrained, linear discriminant function τ^{T}x+τ₀ satisfies the boundary value of a linear decision border D₊₁(x): τ^{T}x+τ₀=1.

Given the assumption that D(x)=−1 the linear discriminant function in Eq. (1.20) can be rewritten as:

$$\frac{{x}^{T} τ}{‖ τ ‖} = \frac{{τ}_{0}}{‖ τ ‖} + \frac{1}{‖ τ ‖} , \qquad ( 1.23 )$$

where

$$\frac{\vert - 1 - {τ}_{0} \vert}{‖ τ ‖}$$

is the distance of the linear decision border to the origin. Any point x that satisfies Eq. (1.23) is on the linear decision border D_{—1}(x), and all of the points x on the linear decision border D₋₁(x) exclusively reference τ. Thereby, the constrained, linear discriminant function τ^{T}x+τ₀ satisfies the boundary value of a linear decision border D₋₁(x): τ^{T}x+τ₀−1.

The linear decision borders D₊₁(x) and D₋₁(x) in Eqs (1.22) and (1.23) satisfy the symmetrically balanced constraints

$$- \frac{{τ}_{0}}{‖ τ ‖} + \frac{1}{‖ τ ‖} and - \frac{{τ}_{0}}{‖ τ ‖} - \frac{1}{‖ τ ‖}$$

with respect to the constraint

$$- \frac{{τ}_{0}}{‖ τ ‖}$$

satisfied by the linear decision boundary D₀(x) so that a constrained, linear discriminant function delineates congruent decision regions

$${Z}_{1} ≃$$

that are symmetrically partitioned by the linear decision boundary in Eq. (1.21).

Thereby, τ is an eigenaxis of symmetry which delineates congruent decision regions

$${Z}_{1} ≃$$

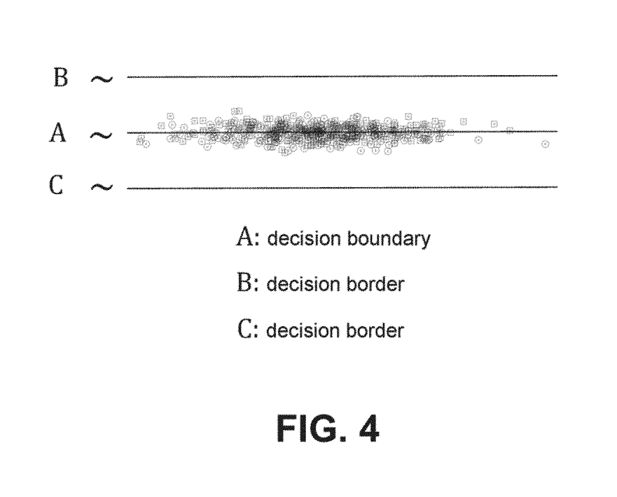

that are symmetrically partitioned by a linear decision boundary, where the span of both decision regions is regulated by the constraints in Eqs (1.21), (1.22), and (1.23). FIG. 4 illustrates congruent decision regions

$${Z}_{1} ≃$$

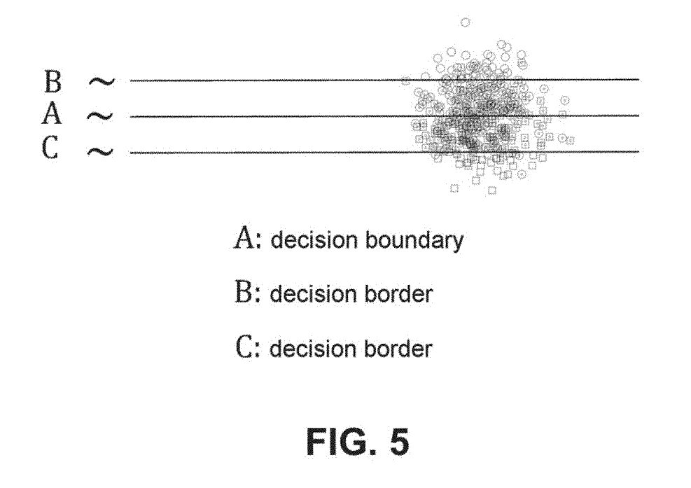

that are symmetrically partitioned by a linear decision boundary for homogeneous data distributions, where τ is an eigenaxis of symmetry. FIG. 5 illustrates congruent decision regions

$${Z}_{1} ≃$$

that are symmetrically partitioned by a linear decision boundary for which τ is an eigenaxis of symmetry.

Using the KKT condition in Eq. (1.15) and the KKT condition of complementary slackness, the following set of locus equations must be satisfied:

yᵢ(x_{i*}^{T}τ+τ₀)−+ξᵢ=0, i=1,

such that τ₀ satisfies the locus equation:

τ₀=Σᵢ₌₁^{l}yᵢ(1−ξᵢ)−Σᵢ₌₁^{l}x_{i*}^{T}τ, (1.24)

Substitution of the equation for τ in Eq. (1.15) and the statistic for τ₀ in Eq. (1.24) into the expression for the linear discriminant function in Eq. (1.20) provides the linear eigenlocus test for classifying an unknown pattern vector x:

$${Λ}_{τ} ( x ) = ( x - {\sum }_{i = 1}^{l} {x}_{{i}^{*}} ) {τ}_{1} - ( x - {\sum }_{i = 1}^{l} {x}_{{i}^{*}} ) {τ}_{2} + {\sum }_{i = 1}^{l} {y}_{i} ( 1 - {ξ}_{i} ) {≷}_{{ω}_{2}} \qquad ( 1.25 )$$

where the statistic Σᵢ₌₁^{l}x_{i*} the locus of an aggregate or cluster of a set of I extreme points, and the statistic Σᵢ₌₁^{l}yᵢ(1−ξᵢ) accounts for the class membership of the primal principal eigenaxis components on τ₁ and τ₂. The cluster Σᵢ₌₁^{l}x_{i*} of a set of extreme points represents the aggregated risk [symbol] for a decision space Z. Accordingly, the vector transform x−Σᵢ₌₁^{l}x_{i*} accounts for the distance between the unknown vector x and the locus of aggregated risk [symbol] .

Let there bel principal eigenaxis components {Ψ_{i*}\vec{e}ᵢ|Ψ_{i*} [symbol] υ}ᵢ₌₁^{l} on Ψ within the Wolfe dual eigenspace.

$$max Ξ ( Ψ ) = {1}^{T} Ψ - \frac{{Ψ}^{T} Q Ψ}{2} ,$$

where w satisfies the constraints Ψ^{T}y=0 and Ψᵢ≥0.

The theorem for convex duality guarantees an equivalence and corresponding symmetry between τ and Ψ. Moreover, Raleigh's principle and the theorem for convex duality indicate that Eq. (1.17) provides an estimate of the largest eigenvector Ψ of a Gram matrix, where Ψ satisfies the constraints Ψ^{T}y=0 and Ψᵢ≥0, such that Ψ is a principal eigenaxis of three, symmetrical hyperplane partitioning surfaces associated with the constrained quadratic Ψ^{T}QΨ.

Equation (1.9) and the theorem for convex duality also indicate that Ψ satisfies an eigenenergy constraint that is symmetrically related to the eigenenergy constraint on τ within its Wolfe dual eigenspace:

∥Ψ∥ₘᵢₙ_{_{c}}²≈∥τ∥ₘᵢₙ_{_{c}}²

Therefore, Ψ satisfies an eigenenergy constraint

maxΨ^{T}QΨ=λ_{maxΨ}∥Ψₘᵢₙ_{_{c}}²

for which the functional 1^{T}Ψ−Ψ^{T}QΨ/2 in Eq. (1.17) is maximized by the largest eigenvector Ψ of Q, such that the constrained quadratic form Ψ^{T}QΨ/2, where Ψ^{T}y=0 and Ψᵢ≥0, reaches its smallest possible value. This indicates that principal eigenaxis components on Ψ satisfy minimum length constraints. Principal eigenaxis components on Ψ also satisfy an equilibrium constraint.

The KKT condition in Eq. (1.12) requires that the magnitudes of the Wolfe dual principal eigenaxis components on Ψ satisfy the equation:

(yᵢ=1)Σᵢ₌₁^{l}^{₁}Ψ_{1i*}+(yᵢ=−1)Σᵢ₌₁^{l}^{₂}Ψ_{2i*}=0

so that

Σᵢ₌₁^{l}^{₁}Ψ_{1i*}−Σᵢ₌₁^{l}^{₂}Ψ_{2i*}+0. (1.26)

It follows that the integrated lengths of the Wolfe dual principal eigenaxis components correlated with each pattern category must balance each other:

Σᵢ₌₁^{l}^{₁}Ψ_{1i*}≡Σᵢ₌₁^{l}^{₂}Ψ_{2i*}. (1.27)

Accordingly, let l₁+l₂=l and express Ψ in terms of l non-orthogonal unit vectors

$$\{ {ψ}_{1 {i}^{*}} {\vec{e}}_{i} , {… }_{i = 1}$$

$$\begin{matrix}Ψ = {\sum }_{i = 1}^{l} {ψ}_{1 {i}^{*}} {\vec{e}}_{{i}^{*}} \\ = {\sum }_{i = 1}^{{l}_{1}} {ψ}_{1 {i}^{*}} {\vec{e}}_{1 {i}^{*}} + {\sum }_{i = 1}^{l} {ψ}_{2 {i}^{*}} {\vec{e}}_{2 {i}^{*}} \\ {Ψ}_{1} + {Ψ}_{2} ,\end{matrix} \qquad ( 1.28 )$$

where each scaled, non-orthogonal unit vector

$${ψ}_{1 {i}^{*}} {\vec{e}}_{1 {i}^{*}} or {ψ}_{2 {i}^{*}} {\vec{e}}_{2 {i}^{*}}$$

is correlated with an extreme vector x_{1i*} or x_{2i*} respectively, Ψ₁ denotes the Wolfe dual eigenlocus component

$${\sum }_{i = 1}^{{l}_{1}} {ψ}_{1 {i}^{*}} {\vec{e}}_{1 {i}^{*}} ,$$

and ω₂ denotes the Wolfe dual eigenlocus component

$${\sum }_{i = 1}^{{l}_{2}} {ψ}_{2 {i}^{*}} {\vec{e}}_{2 {i}^{*}} .$$

Given Eq. (1.27) and data distributions that have dissimilar covariance matrices, it follows that the forces associated with Bayes' counter risks and Bayes' risks, within each of the congruent decision regions, are balanced with each other. Given Eq. (1.27) and data distributions that have similar covariance matrices, it follows that the forces associated with Bayes' counter risks within each of the symmetrical decision regions are equal to each other, and the forces associated with Bayes' risks within each of the symmetrical decision regions are equal to each other.

Given Eqs (1.27) and (1.28), the axis of Ψ can be regarded as a lever that is formed by sets of principal eigenaxis components which are evenly or equally distributed over either side of the axis of Ψ, where a fulcrum is placed directly under the center of the axis of Ψ. Thereby, the axis of Ψ is in statistical equilibrium, where all of the principal eigenaxis components on Ψ are equal or in correct proportions, relative to the center of Ψ, such that the opposing forces associated with Bayes' risks and Bayes' counter risks of a linear classification system are balanced with each other.

Using Eq. (1.27), it follows that the length ∥Ψ₁∥ of Ψ₁ is balanced with the length ∥Ψ₂∥ of Ψ₂:

∥Ψ₁∥≡∥Ψ₂∥ (1.29)

and that the total allowed eigenenergies exhibited by Ψ₁ and Ψ₂ are balanced with each other:

∥Ψ₁∥ₘᵢₙ_{_{c}}²≡∥Ψ₂∥ₘᵢₙ_{_{c}}². (1.30)

Therefore, the equilibrium constraint on Ψ in Eq. (1.27) ensures that the total allowed eigenenergies exhibited by the Wolfe dual principal eigenaxis components on Ψ₁ and Ψ₂ are symmetrically balanced with each other:

$${‖ {\sum }_{i = 1}^{{l}_{1}} {ψ}_{1 {i}^{*}} {\vec{e}}_{1 {i}^{*}} ‖}_{{min}_{c}} = {‖ {\sum }_{i = 1}^{{l}_{2}} {ψ}_{2 {i}^{*}} {\vec{e}}_{2 {i}^{*}} ‖}_{{min}_{c}}$$

about the center of total allowed eigenenergy Ψ₂∥ₘᵢₙ_{_{c}}²: which is located at the geometric center of Ψ because ∥Ψ₁∥≡∥Ψ₂∥. This indicates that the total allowed eigenenergies of Ψ are distributed over its axis in a symmetrically balanced and well-proportioned manner.

Given Eqs (1.29) and (1.30), the axis of Ψ can be regarded as a lever that has equal weight on equal sides of a centrally placed fulcrum. Thereby, the axis of is a lever that has an equal distribution of eigenenergies on equal sides of a centrally placed fulcrum.

The eigenspectrum of the Gram matrix Q determines the shapes of the quadratic surfaces associated with Ψ that are specified by the constrained quadratic form in Eq. (1.17). Furthermore, the eigenvalues of any given Gram or kernel matrix Q are essentially determined by its inner product elements φ(xᵢ, xⱼ), so that the geometric shapes of the three, symmetrical hyperplane partitioning surfaces determined by Eqs (1.16) and (1.17) are an inherent function of inner product statistics. Thereby, the form of the inner product statistics φ(xᵢ, xⱼ) contained within the Gram matrix Q essentially determines the geometric shapes of the linear decision boundary D₀(s)=0 in Eq. (1.21) and the linear decision borders D₊₁(s)=+1 and D₋₁(s)=−1 in Eqs (1.22) and (1.23).

The inner product relationship x^{γ}y=∥x∥∥y∥cosφ between two vectors x and y can be derived by using the law of cosines:

∥x−y∥²=∥x∥²+∥y∥²−2∥x∥∥y∥ cos φ

which reduces to

∥x∥∥y∥ cos φ=x₁y₁+x₂y₂+

so that

x^{T}y=∥x∥∥y∥ cos φ=x−y∥.

Thereby, inner product statistics determine a rich system of geometric and topological relationships between vectors.

A Wolfe dual quadratic eigenlocus Ψ can be written as:

$$Ψ = \frac{{ψ}_{1}}{{λ}_{max Ψ}} ( \begin{matrix}‖ {x}_{1} ‖ ‖ {x}_{1} ‖ cos {θ}_{{x}_{1} {x}_{1}} \\ ‖ {x}_{2} ‖ ‖ {x}_{2} ‖ cos {θ}_{{x}_{2} {x}_{1}} \\ ⋮ \\ - ‖ {x}_{N} ‖ ‖ {x}_{1} ‖ cos {θ}_{{x}_{N} {x}_{1}}\end{matrix} ) + … {λ}_{max Ψ} ( \begin{matrix}- ‖ {x}_{1} ‖ ‖ {x}_{N} ‖ cos {θ}_{{x}_{1} {x}_{N}} \\ - ‖ {x}_{2} ‖ ‖ {x}_{N} ‖ cos {θ}_{{x}_{2} {x}_{N}} \\ ⋮ \\ ‖ {x}_{N} ‖ ‖ {x}_{N} ‖ cos {θ}_{{x}_{N} {x}_{N}}\end{matrix} ) , \qquad ( 1.31 )$$

which illustrates that Ψ₁ is correlated with scalar projections ∥x₁∥cosθₓ_{ᵢ}ₓ_{ⱼ} of the vector xⱼ onto labeled vectors xᵢ. Further, it has been demonstrated that Ψⱼ is correlated with a first and second-order statistical moment about the locus of xⱼ, where a first and second-order statistical moment involves a pointwise covariance statistic covᵤₚ(xᵢ):

covᵤₚ(xᵢ)=∥xᵢ∥Σⱼ₌₁^{N}∥xⱼ∥ cos θₓ_{ᵢ}ₓ_{ⱼ}

that provides a unidirectional estimate of the joint variations between the random variables of each training vector xⱼ in a training data collection and the random variables of a fixed vector xᵢ and a unidirectional estimate of the joint variations between the random variables of the mean vector Σⱼ₌₁^{N}xⱼ and the fixed vector xᵢ, along the axis of the fixed vector xᵢ.

Each extreme vector x_{1i*} and x_{2i*} exhibits a critical first and second-order statistical moment covᵤₚ(x_{1i*}) and covᵤₚ(x_{2i*}) that exceeds some threshold ϑ, for which each corresponding scale factor Ψ_{1i*} and Ψ_{2i*} exhibits a critical value that exceeds zero: Ψ_{1i*}>0 and Ψ_{2i*}>0.

Let the extreme vectors x_{1i*} and x_{2i*} that belong to class ω₁ and ω₂ have labels yᵢ=1 and yᵢ=−1 respectively. Let there be l₁ extreme vectors from class ω₁ and l₂ extreme vectors from class ω₂.

Let i=1:l₁, where each extreme vector x_{1i*} is correlated with a Wolfe principal eigenaxis component

$${ψ}_{1 {i}^{*}} {\vec{e}}_{1 {i}^{*}} .$$

The Wolfe dual eigensystem in Eq. (1.31) can be used to show that the locus of

$${ψ}_{1 {i}^{*}} {\vec{e}}_{1 {i}^{*}}$$

is a function of the expression:

Ψ_{1i*}=λ_{maxΨ}⁻¹∥x_{1i*}∥Σⱼ₌₁^{l}^{₁}Ψ_{1j*}∥x_{1j*}∥cos θₓ_{_{1i*}}ₓ_{_{1j*}}−λ_{maxΨ}⁻¹∥x_{1i*}∥Σⱼ₌₁^{l}^{₂}Ψ_{2j*}∥x_{2j*}∥cos θₓ_{_{1i*}}ₓ_{_{2j*}} (1.32)

where Ψ_{1i*} provides a scale factor for

$$\frac{{x}_{1 {i}^{*}}}{‖ {x}_{1 {i}^{*}} ‖} .$$

Let i=1:l₂, where each extreme vector x_{2i*} is correlated with a Wolfe principal eigenaxis component

$${ψ}_{2 {i}^{*}} {\vec{e}}_{2 {i}^{*}} .$$

The Wolfe dual eigensystem in Eq. (1.31) can be used to show that the locus of

$${ψ}_{2 {i}^{*}} {\vec{e}}_{2 {i}^{*}}$$

is a function of the expression.

Ψ_{2i*}=λ_{maxΨ}⁻¹∥x_{2i*}∥Σⱼ₌₁^{l}^{₁}Ψ_{2j*}∥x_{2j*}∥cos θₓ_{_{2i*}}ₓ_{_{2j*}}−λ_{maxΨ}⁻¹∥x_{2i*}∥Σⱼ₌₁^{l}^{₁}Ψ_{1j*}∥x_{1j*}∥cos θₓ_{_{1i*}}ₓ_{_{1j*}} (1.32)

where Ψ_{2i*} provides a scale factor for

$$\frac{{x}_{2 {i}^{*}}}{‖ {x}_{2 {i}^{*}} ‖} .$$

Equations (1.32) and (1.33) have been used to demonstrate that any given Wolfe dual principal eigenaxis component Ψ_{1i*}\vec{e}_{1i*} correlated an x_{1i*} extreme point and any given Wolfe dual principal eigenaxis component Ψ_{2i*}\vec{e}_{2i*} correlated with an X_{2i*} extreme point provides an estimate for how the components of I scaled extreme vectors {Ψ_{j*}x_{j*}}ⱼ₋^{l} are symmetrically distributed along the axis of a correlated extreme vector x_{1i*} or X_{2i*}, where components of scaled extreme vectors Ψ_{j*}x_{j*} are symmetrically distributed according to class labels ±1, signed magnitudes ∥x_{j*}∥cosθₓ_{_{1i*}}ₓ_{_{j*}} or ∥x_{j*}∥cosθₓ_{_{2i*}}ₓ_{_{j*}} and symmetrically balanced distributions of scaled extreme vectors {Ψ_{k*}x_{k*}}ₖ₋^{l} specified by scale factors Ψ_{j*}.

Accordingly, Ψ is formed by a locus of scaled, normalized extreme vectors

$$Ψ = {\sum }_{i = 1}^{{l}_{1}} {ψ}_{1 {i}^{*}} \frac{{x}_{1 {i}^{*}}}{‖ {x}_{1 {i}^{*}} ‖} + {\sum }_{i = 1}^{{l}_{2}} {ψ}_{2 {i}^{*}} \frac{{x}_{2 {i}^{*}}}{‖ {x}_{2 {i}^{*}} ‖} = {Ψ}_{1} + {Ψ}_{2}$$

where each scale factor Ψ_{1i*} or Ψ_{2i*} provides a unit measure, i.e., estimate, of density and likelihood for a respective extreme point x_{1i*} or x_{2i*}.

Therefore, conditional densities Ψ_{1i*}x_{1i*} for the x_{1i*} extreme points are distributed over the principal eigenaxis components of τ₁

τ₁=Σᵢ₌₁^{l}^{₁}Ψ_{1i*}x_{1i*} (1.34)

so that τ₁ is a parameter vector for a class-conditional probability density p(x_{1i*}|τ₁) for a given set {x_{1i*}}ᵢ₌₁^{l}^{₁} of x_{1i*} extreme points:

τ₁=p(x_{1i*}|τ₁),

where the area under Ψ_{1i*}x_{1i*} is a conditional probability that an extreme point x_{1i*} will be observed in either region Z₁ or region Z₂.

Likewise, conditional densities Ψ_{2i*}x_{2i*} for the x_{2i*} extreme points are distributed over the principal eigenaxis components of τ₂

τ₂=Σᵢ₌₁^{l}^{₂}Ψ_{2i*}x_{2i*} (1.35)

so that τ₂ is a parameter vector for a class-conditional probability density p(x_{2i*}|τ₂) for a given set {x_{2i*}}ᵢ₌₁^{l}^{₂} of x_{2i*} extreme points:

τ₂=p(x_{2i*}|τ₂),

where the area under Ψ_{2i*}x_{2i*} is a conditional probability that an extreme point x_{2i*} will be observed in either region Z₁ or region Z₂.

The area P(x_{1i*}|τ₁) under the class-conditional density function p(x_{1i*}|τ₁) in Eq. (1.34)

$$\begin{matrix}P ( {x}_{1 {i}^{*}} \vert {τ}_{1} ) = {\int }_{Z} ( {\sum }_{i = 1}^{{l}_{1}} {ψ}_{1 {i}^{*}} {x}_{1 {i}^{*}} ) d {τ}_{1} = {\int }_{Z} p ( {x}_{1 {i}^{*}} \vert {τ}_{1} ) d {τ}_{1} \\ = {\int }_{Z} {τ}_{1} d {τ}_{1} = \frac{1}{2} {‖ {τ}_{1} ‖}^{2} + C = {‖ {τ}_{1} ‖}^{2} + {C}_{1}\end{matrix}$$

specifies the conditional probability of observing a set {x_{1i*}}ᵢ₌₁^{l}^{₁} of x_{1i*} extreme points:

extreme points within localized regions of the decision space Z, where conditional densities Ψ_{1i*}x_{1i*} for x_{1i*} extreme points that lie in the Z₂ decision region contribute to the cost or risk [symbol] (Z₂|Ψ_{1i*}x_{1i*}) of making a decision error, and conditional densities Ψ_{1i*}x_{1i*} for x_{1i*} extreme points that lie in the Z₁ decision region counteract the cost or risk [symbol] (Z₁|Ψ_{1i*}x_{1i*}) of making a decision error.

Therefore, the conditional probability function P(x_{1i*}|τ₁) for class Ω₁ is given by the integral

P(x_{1i*}|τ₁)=∫_{Z}τ₁dτ₁=∥τ₁∥²+C₁, (1.36)

over the decision space Z, which has a solution in terms of the critical minimum eigenenergy ∥τ₁∥ₘᵢₙ_{_{c}}² exhibited by τ₁ and an integration constant C₁.

The area P(x_{2i*}|τ₂) under the class-conditional density function p(x_{2i*}|τ₂) in Eq. (1.35)

$$\begin{matrix}P ( {x}_{2 {i}^{*}} \vert {τ}_{2} ) = {\int }_{Z} ( {\sum }_{i = 1}^{{l}_{2}} {ψ}_{2 {i}^{*}} {x}_{2 {i}^{*}} ) d {τ}_{2} = {\int }_{Z} p ( {x}_{2 {i}^{*}} \vert {τ}_{2} ) d {τ}_{2} \\ = {\int }_{Z} {τ}_{2} d {τ}_{2} = \frac{1}{2} {‖ {τ}_{2} ‖}^{2} + C = {‖ {τ}_{2} ‖}^{2} + {C}_{2}\end{matrix}$$

specifies the conditional probability of observing a set {x_{2i*}}ᵢ₌₁^{l}^{₂} of x_{2i*} extreme points within localized regions of the decision space Z, where conditional densities Ψ_{2i*}x_{2i*} Ψ_{2i*}k_{2i*} for x_{2i*} extreme points that lie in the Z₁ decision region contribute to the cost or risk [symbol] (Z₁|Ψ_{2i*}x_{2i*}) of making a decision error, and conditional densities Ψ_{2i*}x_{2i*} for x_{2i*} extreme points that lie in the Z₂ decision region counteract the cost or risk [symbol] (Z₂|Ψ_{2i*}x_{2i*}) of making a decision error.

Therefore, the conditional probability function P(x_{2i*}|τ₂) for class ω₂ is given by the integral

P(x_{2i*}|τ₂)=∫_{Z}τ₂dτ₂=∥τ₂∥²+C₂, (1.37)

over the decision space Z, which has a solution in terms of the critical minimum eigenenergy ∥τ₂∥ₘᵢₙ_{_{c}}² exhibited by ρ₂ and an integration constant C₂.

Linear eigenlocus transforms routinely accomplish an elegant, statistical balancing feat that involves finding the right mix of principal eigenaxis components on Ψ and τ. The scale factors {Ψ_{i*}}ᵢ₌₁^{l} of the principal eigenaxis components on Ψ play a fundamental role in this statistical balancing feat.

Using Eq. (1.32), the integrated lengths Σᵢ₌₁^{l}^{₁}Ψ_{1i*} of of the principal eigenaxis components on Ψ₁ must satisfy the equation:

Σᵢ₌₁^{l}^{₁}Ψ_{1i*}=λ_{maxΨ}⁻¹Σᵢ₌₁^{l}^{₁}x_{1i*}^{T}(Σⱼ₌₁^{l}^{₁}Ψ_{1j*}x_{1j*}−Σⱼ₌₁^{l}^{₂}Ψ_{2j*}x_{2j*}), (1.38)

and, using Eq. (1.33), the integrated lengths Σᵢ₌₁^{l}^{₂}Ψ_{2i*} of the principal eigenaxis components on Ψ₂ must satisfy the equation:

Σᵢ₌₁^{l}^{₂}Ψ_{2i*}=λ_{maxΨ}⁻¹Σᵢ₌₁^{l}^{₂}x_{2i*}^{T}(Σⱼ₌₁^{l}^{₂}Ψ_{2j*}x_{2j*}−Σⱼ₌₁^{l}^{₁}Ψ_{1j*}x_{1j*}), (1.39)

Returning to Eq. (1.27) where the axis of Ψ is in statistical equilibrium, it follows that the RHS of Eq. (1.38) must equal the RHS of Eq. (1.39):

Σᵢ₌₁^{l}^{₁}x_{1i*}^{T}(Σⱼ₌₁^{l}^{₁}Ψ_{1j*}x_{1j*}−Σⱼ₌₁^{l}^{₂}Ψ_{2j*}x_{2j*})=Σᵢ₌₁^{l}^{₂}x_{2i*}^{T}(Σⱼ₌₁^{l}^{₂}Ψ_{2j*}x_{2j*}−Σⱼ₌₁^{l}^{₂}Ψ_{1j*}x_{1j*}), (1.40)

whereby all of the x_{1i*} ,and x_{2i*}, extreme points are distributed over the axes of τᵢ and τ₂ in the symmetrically balanced manner:

Σᵢ₌₁^{l}^{₁}x_{1i*}^{T}(τ₁−τ₂)=Σᵢ₌₁^{l}^{₂}x_{2i*}^{T}(τ₂−τ₁), (1.41)

where the components of the x_{1i*} extreme vectors along the axis of τ₂ oppose the components of the x_{1i*} extreme vectors along the axis of τ₁, and the components of the x_{2i*} extreme vectors along the axis of τₜ oppose the components of the x_{2i*} extreme vectors along the axis of τ₂.

Rewrite Eq. (1.41) as:

Σᵢ₌₁^{l}^{₁}x_{1i*}^{T}τ₁+Σᵢ₌₁^{l}^{₂}x_{2i*}^{T}τ₁=Σᵢ₌₁^{l}^{₁}x_{1i*}^{T}τ₂+Σᵢ₌₁^{l}^{₂}x_{2i*}^{T}τ₂ (1.42)

where the components of the x_{1i*} and x_{2i*} extreme vectors along the axes of τ₁ and ‘r₂ have forces associated with Bayes’ risks and Bayes' counter risks that are functions of symmetrically balanced expected values and spreads of x_{1i*} and x_{2i*} extreme points located in the Z₁ and Z₂ or decision regions. Therefore, for any given collection of extreme points drawn from any given statistical distribution, all of the aggregate forces associated with Bayes' risks and Bayes' counter risks on the axis of τ₁ are balanced with all of the aggregate forces associated with Bayes' risks and Bayes' counter risks on the axis of τ₂.

So, let

$${\hat{x}}_{{i}^{*}} {=}^{Δ} .$$

Using Eq. (1.42), it follows that the component of \hat{x}_{i*} along τ₁ is symmetrically balanced with the component of \hat{x}_{i*} along τ₂

$${\begin{matrix}{{comp}_{\vec{{τ}_{1}}}}_{‵ \cdot ′}^{′ \to } & { }_{- \vec{{τ}_{2}}}\end{matrix}}_{‵ \cdot ′}^{′ \to }$$

so that the components

$${{comp}_{\vec{{τ}_{1}}}}_{‵ \cdot *}^{′ \to } , and {{comp}_{\vec{{τ}_{2}}}}_{‵ \cdot *}^{′ \to } ,$$

of clusters or aggregates of the extreme vectors from both pattern classes have equal forces associated with Bayes' risks and Bayes' counter risks on opposite sides of the axis of τ.

Given Eq. (1.42), the axis of τ can be regarded as a lever of uniform density, where the center of τ is ∥τ∥ₘᵢₙ², for which two equal weights

$$comp {->}_{{τ}_{1}} \text{?} and comp {->}_{{τ}_{2}} \text{?}$$

$$\text{?} \text{indicates text missing or illegible when filed}$$

are placed on opposite sides of the fulcrum of τ, whereby the axis of τ is in statistical equilibrium.

Equation (1.40) indicates that the lengths {Ψ_{1i*}|Ψ_{1i*}>0}ᵢ₌₁^{l}^{₁} and {Ψ_{2i*}|Ψ_{2i*}>0}ᵢ₌₁^{l}^{₂} of the l Wolfe dual principal eigenaxis components on Ψ satisfy critical magnitude constraints, such that the Wolfe dual eigensystem in Eq. (1.17) determines well-proportioned lengths Ψ_{1i*} or Ψ_{2i*} for each Wolfe dual principal eigenaxis component on Ψ₁ or Ψ₂, where each scale factor Ψ_{1i*} or Ψ_{2i*} determines a well-proportioned length for a correlated, constrained primal principal eigenaxis component or Ψ_{1i*},x_{1i*} or Ψ_{2i*},x_{2i*} on τ₁ or τ₂.

Moreover, linear eigenlocus transforms generate scale factors for the Wolfe dual principal eigenaxis components on Ψ, which is constrained to satisfy the equation of statistical equilibrium in Eq. (1.27), such that the likelihood ratio Λ_{τ}(x)=τ₁−τ₂ and the classification system

$${τ}^{T} x + {τ}_{0} {≷}_{{ω}_{2}}$$

are in statistical equilibrium, and the Bayes' risk [symbol] (Z|Λ_{τ}(x)) and the corresponding total allowed eigenenergies ∥τ₁−τ₂∥ₘᵢₙ_{ₓ}² exhibited by the classification system

$${τ}^{T} x + {τ}_{0} {≷}_{{ω}_{2}}$$

are minimized.

A system of data-driven, locus equations that determines the manner n which the total allowed eigenenergies of the scaled extreme points on τ₁−τ₂ are symmetrically balanced about the fulcrum ∥τ∥ₘᵢₙ_{_{c}} ² of τ is presented next.

Let there be l labeled, scaled extreme points on τ. Given the theorem of Karush, Kuhn, and Tucker and the KKT condition in Eq. (1.15), it follows that a Wolf dual quadratic Ψexists for which:

{Ψ_{1i*}>0}ᵢ₌₁^{l}

such that the l constrained, primal principal eigenaxis components {Ψ_{1i*}x_{1i*}}ᵢ₌₁^{l} on τ satisfy a system of l eigenlocus equations:

Ψ_{i*}[yᵢ(x_{i*}^{T}τ+τ₀)−1+ξᵢ]=0, i=1 (1.43)

Take any scaled extreme vector Ψ_{1i*}x_{1i*} that belongs to class ω₁. Using Eq. (1,43) and letting yᵢ++1, it can be shown that the total allowed eigenenergy ∥τ₁∥ₘᵢₙ_{_{c}}² exhibited by τ₁ is determined by the identity

∥τ₁∥ₘᵢₙ_{_{c}}²−∥τ₁∥∥τ₂∥ cos θ_{τ}_{₁}_{τ}_{₂}≡Σᵢ₌₁^{l}^{₁}Ψ_{1i*}(1−ξᵢ−τ₀) (1.44)

so that a constrained, linear discriminant function τ^{T}x+τ₀ satisfies the linear decision border D₋₁(x): τ^{T}x+τ₀=1 in terms of the total allowed eigenenergy ∥τ₁∥ₘᵢₙ_{_{c}}² exhibited by τ₁, where the functional ∥τ₁∥ₘᵢₙ_{_{c}}²−∥τ₁∥∥τ₂∥cosθ_{τ}_{₁}_{τ}_{₂} is constrained by the functional Σᵢ₌₁^{l}^{₁}Ψ_{1i*}(1−ξᵢ−τ₀).

Take any scaled extreme vector Ψ_{2i*},x_{2i*} that belongs to class ω₂. Using Eq. (1.43) and letting yᵢ=−1, it can be shown that the total allowed eigenenergy ∥τ₁∥ₘᵢₙ_{_{c}}² exhibited by τ₂ is determined by the identity

∥τ₁∥ₘᵢₙ_{_{c}}²−81 τ₁∥ₘᵢₙ_{_{c}}²−∥τ₁∥∥τ₂∥ cos θ_{τ}_{₂}_{τ}_{₁}≡Σᵢ₌₁^{l}^{₁}Ψ_{2i*}(1−ξᵢ−τ₀) (1.45)

so that a constrained, linear discriminant function τ^{T}x+τ₀ satisfies the linear decision border D₋(x): τ^{T}x+τ₀=−1 in terms of the total allowed eigenenergy ∥τ₁∥ₘᵢₙ_{_{c}}² exhibited by τ₂, where the functional ∥τ₂∥ₘᵢₙ_{_{c}}²−∥τ₂∥∥τ₁∥cosθ_{τ}_{₂}_{τ}_{₁} is constrained by the functional Σᵢ₌₁^{l}^{₂}Ψ_{2i*}(1−ξᵢ−τ₀).

Summation over the complete system of eigenlocus equations satisfied by τ₁

(Σᵢ₌₁^{l}^{₁}Ψ1i*x_{1i*}^{T})τ=Σᵢ₌₁^{l}^{₁}Ψ_{1i*}(1−ξᵢ−τ₀)

and by τ₂

(−Σᵢ₌₁^{l}^{₂}Ψ2i*x_{2i*}^{T})τ=Σᵢ₌₁^{l}^{₂}Ψ_{2i*}(1−ξᵢ−τ₀)

produces the following identity that is satisfied by the total allowed eigenenergy ∥τ₁∥ₘᵢₙ_{_{c}}² of τ

(τ₁−τ₂)τ≡Σᵢ₌₁^{l}^{₁}Ψ_{1i*}(1−ξᵢ−τ₀)+Σᵢ₌₁^{l}^{₂}Ψ_{2i*}(1−ξᵢ−τ₀)≡Σᵢ₌₁^{l}^{₁}Ψ_{1i*}(1−ξᵢ), (1.46)

where the equilibrium constraint on Ψ in Eq.(1.27) has been used.

Thus, the total allowed eigenenergy ∥τ₁∥ₘᵢₙ_{_{c}}² exhibited by τ is specified by the integrated magnitudes Ψ_{1i*} of the Wolfe dual principal eigenaxis components on Ψ

∥τ∥ₘᵢₙ_{_{c}}²≡Σᵢ₌₁^{l}Ψ_{1i*}(1−ξᵢ)≡Σᵢ₌₁^{l}Ψ_{1i*}−Σᵢ₌₁^{l}Ψ_{1i*}ξᵢ, (1.47)

where the regularization parameters ξᵢ=ξ<< are seen to determine negligible constraints ∥τ∥ₘᵢₙ_{_{c}}², so that a constrained, linear discriminant function τ^{T}x+τ₀ satisfies the boundary value of a linear decision boundary D₀(x): τ^{T}x+τ₀ in terms of its total allowed eigenenergy ∥τ∥ₘᵢₙ_{_{c}}², where the functional ∥τ∥ₘᵢₙ_{_{c}}² is constrained by the functional Σᵢ₌₁^{l}Ψ_{2i*}(1−ξᵢ).

Using Eqs (1.44), (1.45), and (1.46), it follows that the symmetrically balanced constraints

E_{Ψ}_{₁}=Σᵢ₌₁^{l}^{₁}Ψ_{1i*}(1−ξᵢ−τ₀) and E_{Ψ}_{₂}=Σᵢ₌₁^{l}^{₂}Ψ_{2i*}(1−ξᵢ−τ₀)

satisfied by a linear discriminant function on the respective linear decision borders D₊₁(x) and D₋₁(x), and the corresponding constraint

E_{Ψ}=Σᵢ₌₁^{l}^{₁}Ψ_{1i*}(1−ξᵢ−τ₀)+Σᵢ₌₁^{l}^{₂}Ψ_{2i*}(1−ξᵢ−τ₀)

satisfied by a linear discriminant function on the linear decision boundary D₀(x), ensure that the total allowed eigenenergies ∥τ₁−τ₂∥ₘᵢₙ_{_{c}}² exhibited by the scaled extreme points on τ₁τ₂ satisfy the law of cosines in the symmetrically balanced manner:

∥τ∥ₘᵢₙ_{_{c}}²=[∥τ₁∥ₘᵢₙ_{_{c}}²−∥τ₁∥∥τ₂∥ cos θ_{τ}_{₁}_{τ}_{₂}]+[∥τ₂∥ₘᵢₙ_{_{c}}²−∥τ₂∥∥τ₁∥ cos θ_{τ}_{₂}_{τ}_{₁}].

Furthermore, it has been shown that ∥τ₁∥ₘᵢₙ_{_{c}}² and ∥τ₂∥ₘᵢₙ_{_{c}} ² are symmetrically balanced with each other in the following manner:

∥τ₁∥ₘᵢₙ_{_{c}}²−∥τ₁∥∥τ₂∥ cos θ_{τ}_{₁}_{τ}_{₂}+δ(y)½Σᵢ₌₁^{l}Ψ_{i*}≡½∥τ∥ₘᵢₙ_{_{c}}²,

and

∥τ₂∥ₘᵢₙ_{_{c}}²−∥τ₂∥∥τ₁∥ cos θ_{τ}_{₂}_{τ}_{₁}+δ(y)½Σᵢ₌₁^{l}Ψ_{i*}≡½∥τ∥ₘᵢₙ_{_{c}}²,

where the equalizer statistic

$$δ ( y ) \frac{1}{2} {\sum }_{i = 1}^{l} {ψ}_{{i}^{*}} \text{:} δ ( y ) {=}^{Δ} \text{?} - {ξ}_{i} ) \\ \text{?} \text{indicates text missing or illegible when filed} \qquad ( 1.48 )$$

equalizes the total allowed eigenenergies ∥τ₁∥ₘᵢₙ_{_{c}}² and ∥τ₂∥ₘᵢₙ_{_{c}}² exhibited by τₜ and τ₂ so that the total allowed eigenenergies ∥τ₁−τ₂∥ₘᵢₙ_{_{c}}² exhibited by the scaled extreme points on τ₁−τ₂ are symmetrically balanced with each other about the fulcrum of τ:

∥κ₁∥ₘᵢₙ_{_{c}}²+δ(y)½Σᵢ₌₁^{l}Ψ_{i*}≡∥κ₂∥ₘᵢₙ_{_{c}}²−δ(y)½Σᵢ₌₁^{l}Ψ_{i*} (1.49)

which is located at the center of eigenenergy ∥τ∥ₘᵢₙ_{_{c}}² the geometric center of τ. Thereby, the eigenenergy ∥τ₁∥ₘᵢₙ_{_{c}}² associated with the position or location of the likelihood ratio p(Λ_{τ}(x)|ω₁) given class ω₁ is symmetrically balanced with the eigenenergy ∥τ₂∥ₘᵢₙ_{_{c}}² associated with the position or location of the likelihood ratio p(Λ_{τ}(x)|ω₂) given class ω₂ so that the likelihood ratio

Λ_{τ}(x)=p(Λ_{τ}(x)|ω₁)−p(Λ_{τ}(x)|ω₁)=τ₁=τ₂

of the classification system

$${τ}^{T} x + {τ}_{0} {≷}_{{ω}_{2}}$$

is in statistical equilibrium.

Returning to Eq. (1.36)

P(x_{1i*}|τ₁)=∫_{Z}τ₁dτ₁=∥τ₁∥²+C₁

### and Eq. (1.37)

P(x_{2i*}|τ₂)=∫_{Z}τ₂dτ₂=∥τ₂∥²+C₂,

it follows that the value for the integration constant C₁ in Eq. (1.36) is

C₁=−∥τ₁∥∥τ₂∥ cos θ_{τ}_{₁}_{τ}_{₂}

and the value for the integration constant C₂ in Eq. (1.37) is

C₂=−∥τ₂∥∥τ₁∥ cos θ_{τ}_{₂}_{τ}_{₁}.

Therefore, the area P(x_{1i*}|τ₁) under the class-conditional density function p(x_{1i*}|τ₁) in Eq. (1.36):

$$\begin{matrix}P ( {x}_{1 {i}^{*}} \vert {τ}_{1} ) = {\int }_{Z} p ( {x}_{1 {i}^{*}} \vert {τ}_{1} ) d {τ}_{1} + δ ( y ) \frac{1}{2} {\sum }_{i = 1}^{l} {ψ}_{{i}^{*}} \\ = {\int }_{Z} {τ}_{1} d {τ}_{1} + δ ( y ) \frac{1}{2} {\sum }_{i = 1}^{l} {ψ}_{{i}^{*}} \\ = {‖ {τ}_{1} ‖}_{m i {n}_{c}}^{2} - ‖ {τ}_{1} ‖ ‖ {τ}_{2} ‖ cos {θ}_{{τ}_{1} {τ}_{2}} + δ ( y ) {\sum }_{i = 1}^{{l}_{1}} {ψ}_{1 {i}^{*}} \\ ≡ \frac{1}{2} {‖ τ ‖}_{m i {n}_{c}}^{2} ,\end{matrix} \qquad ( 1.50 )$$

over the decision space Z, is symmetrically balanced with the area under the class-conditional density function p(x_{2i*}|τ₂) in Eq. (1.37):

$$\begin{matrix}P ( {x}_{2 {i}^{*}} \vert {τ}_{2} ) = {\int }_{Z} p ( {x}_{2 {i}^{*}} \vert {τ}_{2} ) d {τ}_{2} - δ ( y ) \frac{1}{2} {\sum }_{i = 1}^{l} {ψ}_{{i}^{*}} \\ = {\int }_{Z} {τ}_{2} d {τ}_{2} - δ ( y ) \frac{1}{2} {\sum }_{i = 1}^{l} {ψ}_{{i}^{*}} \\ = {‖ {τ}_{2} ‖}_{m i {n}_{c}}^{2} - ‖ {τ}_{2} ‖ ‖ {τ}_{1} ‖ cos {θ}_{{τ}_{2} {τ}_{1}} + δ ( y ) {\sum }_{i = 1}^{{l}_{2}} {ψ}_{2 {i}^{*}} \\ ≡ \frac{1}{2} {‖ τ ‖}_{m i {n}_{c}}^{2} ,\end{matrix} \qquad ( 1.51 )$$

over the decision space Z, where the area P(x_{1i*}|τ₁) under p(x_{1i*}|τ₁) and the area P(x_{2i*}|τ₂) under p(x_{2i*}|τ₂) are constrained to be equal to ½∥τ∥ₘᵢₙ_{_{c}}² by means of the equalizer statistic in Eq. (1.48).

It follows that the linear discriminant function Λ_{τ}(x)=τ^{T}x+τ₀ is the solution to the integral equation

$$\begin{matrix}f ( {Λ}_{τ} ) = {\int }_{{Z}_{1}} {τ}_{1} d {τ}_{1} + {\int }_{{Z}_{2}} {τ}_{1} d {τ}_{1} + δ ( y ) {\sum }_{i = 1}^{{l}_{1}} {ψ}_{1 {i}^{*}} \\ = {\int }_{{Z}_{1}} {τ}_{2} d {τ}_{2} + {\int }_{{Z}_{2}} {τ}_{2} d {τ}_{2} - δ ( y ) {\sum }_{i = 1}^{{l}_{2}} {ψ}_{2 {i}^{*}} ,\end{matrix} \qquad ( 1.52 )$$

over the decision space Z=Z₁+Z₂ where the dual likelihood ratios Λ_{Ψ}(x)=Ψ₁+Ψ₂and Λ₉₆(x)=τ₁−τ₂ are in statistical equilibrium, so that all of the forces associated with Bayes' counter risks [symbol] (Z₁|τ₁) and Bayes' risks [symbol] (Z₂|τ₁) in the Z₁ and Z₂ decision regions: which are related to positions and potential locations of extreme points x_{1i*} that are generated according to p(x|ω₁), are balanced with all of the forces associated with Bayes' risks [symbol] (Z₁|τ₂) and Bayes' counter risks [symbol] (Z₂|τ₂) in the Z₁ and Z₂ decision regions: which are related to positions and potential locations of extreme points x_{2i*} that are generated according to p(x|ω₂), and the eigenenergy ∥τ₁∥ₘᵢₙ_{_{c}}² associated with the position or location of the likelihood ratio p(Λ_{τ}(x)|ω₁) given class ω₁ is balanced with the eigenenergy ∥τ₂∥ₘᵢₙ_{_{c}}² associated with the position or location of the likelihood ratio p(Λ_{τ}(x)|ω₂) given class ω₂.

Equation (1.52) can be rewritten as:

$$\begin{matrix}f ( {Λ}_{τ} ) = {\int }_{{Z}_{1}} {τ}_{1} d {τ}_{1} - {\int }_{{Z}_{1}} {τ}_{2} d {τ}_{2} + δ ( y ) {\sum }_{i = 1}^{{l}_{1}} {ψ}_{1 {i}^{*}} \\ = {\int }_{{Z}_{2}} {τ}_{2} d {τ}_{2} + {\int }_{{Z}_{2}} {τ}_{1} d {τ}_{1} - δ ( y ) {\sum }_{i = 1}^{{l}_{2}} {ψ}_{2 {i}^{*}} ,\end{matrix} \qquad ( 1.53 )$$

where all of the eigenenergies ∥Ψ_{1i*}x_{1i*}∥ₘᵢₙ_{_{c}}² and ∥Ψ_{2i*}x_{2i*}∥ₘᵢₙ_{_{c}}² associated with Bayes' counter risk [symbol] (Z₁|τ₁) and Bayes' risk [symbol] (Z₁|τ₂) in the Z₁ decision region are symmetrically balanced with all of the eigenenergies ∥Ψ_{2i*}x_{1i*}∥ₘᵢₙ_{_{c}}² and ∥Ψ_{1i*}x_{1i*}∥ₘᵢₙ_{_{c}}² associated with Bayes' counter risk [symbol] (Z₂|τ₂) and Bayes' risk [symbol] (Z₂|τ₁) in the Z₂ decision region.

The equilibrium point of the integral equation in Eq. (1.52) and its derivative in Eq. (1.53) is a dual locus of principal eigenaxis components and likelihoods

$$\begin{matrix}ψ {{=}^{Δ}}_{ψ} {}^{z} p ( {Λ}_{ψ} ( x ) \vert {ω}_{1} ) + p ( {Λ}_{ψ} ( x ) \vert {ω}_{2} ) \\ = {ψ}_{1} + {ψ}_{2} \\ = {\sum }_{i = 1}^{{l}_{1}} {ψ}_{1 {i}^{*}} \frac{{x}_{1 {i}^{*}}}{‖ {x}_{1 {i}^{*}} ‖} + {\sum }_{i = 1}^{{l}_{2}} {ψ}_{2 {i}^{*}} \frac{{x}_{2 {i}^{*}}}{‖ {x}_{2 {i}^{*}} ‖}\end{matrix}$$

that is constrained to be in statistical equilibrium:

$${\sum }_{i = 1}^{{l}_{1}} {ψ}_{1 {i}^{*}} \frac{{x}_{1 {i}^{*}}}{‖ {x}_{1 {i}^{*}} ‖} = {\sum }_{i = 1}^{{l}_{2}} {ψ}_{2 {i}^{*}} \frac{{x}_{2 {i}^{*}}}{‖ {x}_{2 {i}^{*}} ‖} .$$

Therefore, the Bayes' risk [symbol] (Z|Λ_{τ}(x)) and the eigenenergy Eₘᵢₙ(Z|τ) linear classification system

$${τ}^{T} x + {τ}_{0} {≷}_{{ω}_{2}}$$

are governed by the equilibrium point:

Σᵢ₌₁^{l}^{₁}Ψ_{1i*}−Σᵢ₌₁^{l}^{₂}Ψ_{2i*}=0

of the integral equation f(Λ_{τ}) in Eq. (1.52).

The discrete linear classification theorem that is outlined next summarizes the properties of the system of fundamental data-driven locus equations that transforms two given sets of feature vectors into a linear classification system.

Take a collection of d-component random vectors x that are generated according to probability density functions p(x|ω₁) and p(x|ω₂) related to statistical distributions of random vectors x that have constant or unchanging statistics, and let

$${Λ}_{τ} ( x ) = {τ}^{T} x + {τ}_{0} {≷}_{{ω}_{2}}$$

denote the likelihood ratio test for a discrete, linear classification system, where ω₁ or ω₂ is the true data category, is a locus of principal eigenaxis components and likelihoods:

$$\begin{matrix}τ {=}^{Δ} \text{?} \\ = {τ}_{1} - {τ}_{2} \\ = {\sum }_{i = 1}^{{l}_{1}} {ψ}_{1 {i}^{*}} {x}_{1 {i}^{*}} - {\sum }_{i = 1}^{{l}_{2}} {ψ}_{2 {i}^{*}} {x}_{2 {i}^{*}} ,\end{matrix}$$

$$\text{?} \text{indicates text missing or illegible when filed}$$

where

$${x}_{1 {i}^{*}} \text{\textasciitilde} \text{?} ) , {x}_{2 {i}^{*}} \text{\textasciitilde} \text{?} ) , \\ \text{?} \text{indicates text missing or illegible when filed}$$

Ψ_{1i*} and Ψ_{2i*} are scale factors that provide unit measures of likelihood for respective data points x_{1i*} and x_{2i*} which lie in either overlapping regions or tails regions of data distributions related to p(x|ω₁) and p(x|ω₂), and τ₀ is a functional of τ:

τ₀=Σᵢ₌₁^{l}yᵢ(1−ξᵢ)−Σᵢ₌₁^{l}x_{i*}^{T}τ,

where Σᵢ₌₁^{l}x_{i*}=Σᵢ₌₁^{l}^{₂}x_{1i*}+Σᵢ₌₁^{l}^{₂}x_{2i*} is a cluster of the data points x_{1i*} and x_{2i*} used to form Ε, y, are class membership statistics: if x_{1i*}ϵω₁, assign yᵢ=+1; if x_{2i*}ϵω₂, assign yᵢ=−1, and are regularization parameters: ξᵢ=ξ=0 for full rank Gram matrices or ξᵢ=ξ<< for low rank Gram matrices.

The linear discriminant function

Λ_{τ}(x)=τ^{T}x+τ₀

is the solution to the integral equation

$$f ( {Λ}_{τ} ) = {\int }_{{Z}_{1}} {τ}_{1} d {τ}_{1} + {\int }_{{Z}_{2}} {τ}_{1} d {τ}_{1} + δ ( y ) {\sum }_{i = 1}^{{l}_{1}} {ψ}_{1 {i}^{*}} = {\int }_{{Z}_{1}} {τ}_{2} d {τ}_{2} + {\int }_{{Z}_{2}} {τ}_{2} d {τ}_{2} - δ ( y ) {\sum }_{i = 1}^{{l}_{2}} {ψ}_{2 {i}^{*}} ,$$

over the decision space Z=Z₁+Z₂, where Z₁ and Z₂ are congruent decision regions:

$${Z}_{1} ≃ \text{?} and δ ( y ) {=}^{Δ} \text{?} 1 - {ξ}_{i} ) , \\ \text{?} \text{indicates text missing or illegible when filed}$$

such that the Bayes' risk [symbol] (Z|Λ_{τ}(x)) and the corresponding eigenenergy Eₘᵢₙ(Z|τ) of the linear classification system

$${τ}^{T} x + {τ}_{0} {≷}_{{ω}_{2}}$$

are governed by the equilibrium point:

Σᵢ₌₁^{l}^{₁}Ψ_{1i*}−Σᵢ₌₁^{l}^{₂}Ψ_{2i*}=0.

of the integral equation f(Λ_{τ}(x)), where the equilibrium point is a dual locus of principal eigenaxis components and likelihoods

$$\begin{matrix}ψ {=}^{Δ} \text{?} \\ = {ψ}_{1} + {ψ}_{2} \\ = {\sum }_{i = 1}^{{l}_{1}} {ψ}_{1 {i}^{*}} \frac{{x}_{1 {i}^{*}}}{‖ {x}_{1 {i}^{*}} ‖} + {\sum }_{i = 1}^{{l}_{2}} {ψ}_{2 {i}^{*}} \frac{{x}_{2 {i}^{*}}}{‖ {x}_{2 {i}^{*}} ‖}\end{matrix}$$

$$\text{?} \text{indicates text missing or illegible when filed}$$

that is constrained to be in statistical equilibrium:

$${\sum }_{i = 1}^{{l}_{1}} {ψ}_{1 {i}^{*}} \frac{{x}_{1 {i}^{*}}}{‖ {x}_{1 {i}^{*}} ‖} = {\sum }_{i = 1}^{{l}_{2}} {ψ}_{2 {i}^{*}} \frac{{x}_{2 {i}^{*}}}{‖ {x}_{2 {i}^{*}} ‖} .$$

Therefore, the forces associated with Bayes' counter risk [symbol] (Z₁|p(Λ_{τ}(x)|ω₁)) and Bayes' risk [symbol] (Z₂|p(Λ_{τ}(x)|ω₁)) in the Z₁ and Z₂. decision regions: which are related to positions and potential locations of data points x_{1i*} , that are generated according to p(x|ω₁) are balanced with the forces associated with Bayes' risk [symbol] (Z₁|p(Λ_{τ}(x)|ω₂)) ) and Bayes' counter risk [symbol] (Z₂|p(Λ_{τ}(x)|ω₂)) in the Z₁ and Z₂ decision regions: which are related to positions and potential locations of data points x_{2i*} that are generated according to p(x)|ω₂).

Furthermore, the eigenenergy Eₘᵢₙp(Z|p(Λ_{τ}(x)|ω₂)) associated with the position or location of the likelihood ratio p(Λ_{τ}(x)|ω₁) given class ω₁ is balanced with the eigenergy Eₘᵢₙp(Z|p(Λ_{τ}(x)|ω₂)) associated with the position or location of the likelihood ratio p(Λ_{τ}(x)|ω₂) given class ω₂:

∥τ₁∥ₘᵢₙ_{_{c}}²+δ(y)½Σᵢ₌₁^{l}Ψ_{i*}≡∥τ₂∥ₘᵢₙ_{_{c}}²−δ(y)½Σᵢ₌₁^{l}Ψ_{i*}

where the total eigenenergy

$$\begin{matrix}{‖ τ ‖}_{{min}_{c}}^{2} = {‖ {τ}_{1} - {τ}_{2} ‖}_{{min}_{c}}^{2} \\ = [ {‖ {τ}_{1} ‖}_{{min}_{c}}^{2} - ‖ {τ}_{1} ‖ ‖ {τ}_{2} ‖ cos {θ}_{{τ}_{1} {τ}_{2}} ] + \\ [ {‖ τ ‖}_{{min}_{c}}^{2} - ‖ {τ}_{2} ‖ ‖ {τ}_{1} ‖ cos {θ}_{{τ}_{2} {τ}_{1}} ] \\ = {\sum }_{i = 1}^{{l}_{1}} {ψ}_{1 {i}^{*}} ( 1 - {ξ}_{i} ) + {\sum }_{i = 1}^{{l}_{2}} {ψ}_{2 {i}^{*}} ( 1 - {ξ}_{i} ) \\ = {\sum }_{i = 1}^{{l}_{1}} {ψ}_{{i}^{*}} ( 1 - {ξ}_{i} )\end{matrix}$$

of the discrete, linear classification system

$${τ}^{T} x + {τ}_{0} {≷}_{{ω}_{2}}$$

is determined by the eigenenergies associated with the position or location of the likelihood ratio τ=τ₁−τand the locus of a corresponding, linear decision boundary τ^{T}x+τ₀=0.

It follows that the discrete, linear classification system

$${τ}^{T} x + {τ}_{0} {≷}_{{ω}_{2}}$$

is in statistical equilibrium:

$$f ( {Λ}_{τ} ) = {\int }_{{Z}_{1}} {τ}_{1} d {τ}_{1} - {\int }_{{Z}_{1}} {τ}_{2} d {τ}_{2} + δ ( y ) {\sum }_{i = 1}^{{l}_{1}} {ψ}_{1 {i}^{*}} = {\int }_{{Z}_{2}} {τ}_{2} d {τ}_{2} - {\int }_{{Z}_{2}} {τ}_{1} d {τ}_{1} - δ ( y ) {\sum }_{i = 1}^{{l}_{2}} {ψ}_{2 {i}^{*}} ,$$

where the forces associated with Bayes' counter risk [symbol] (Z₁|p(Λ_{τ}(x)|ω₁)) and Bayes' risk [symbol] (Z₁|p(Λ_{τ}(x)|ω₂)) in the Z₁ decision region are balanced with the forces associated with Bayes' counter risk [symbol] (Z₂|p(Λ_{τ}(x)|ω₂)) and Bayes' risk [symbol] (Z₂|p(Λ_{τ}(x)|ω₁)) in the Z₂ decision region such that the Bayes' risk [symbol] (Z|Λ_{τ}(s)) of the classification system is minimized, and the eigenenergies associated with Bayes' counter risk [symbol] (Z₁|τ₁) and Bayes' risk [symbol] (Z₁|τ₂) in the Z₁ decision region are balanced with the eigenenergies associated with Bayes' counter risk [symbol] (Z₂|τ₂) and Bayes' risk [symbol] (Z₂|τ₁) in the Z₂ decision region such that the eigenenergy Eₘᵢₙ (Z|τ) of the classification system is minimized.
Thus, any given discrete, linear classification system

$${τ}^{T} x + {τ}_{0} {≷}_{{ω}_{2}}$$

exhibits an error rate that is consistent with the Bayes' risk [symbol] (Z₁|τ₁(x)) and the corresponding eigenenergy Eₘᵢₙ(Z|τ) of the classification system: for all random vectors x that are generated according to p(x|ω₁) and p(x|ω₂), where p(x|ω₁) and p(x|ω₂) are related to statistical distributions of random vectors x that have similar covariance functions and constant or unchanging statistics.

Thereby, a discrete, linear classification system

$${τ}^{T} x + {τ}_{0} {≷}_{{ω}_{2}}$$

seeks a point of statistical equilibrium where the opposing forces and influences of the classification system are balanced with each other, such that the eigenenergy and the Bayes' risk of the classification system are minimized, and the classification system is in statistical equilibrium.

Furthermore, the eigenenergy ∥τ∥ₘᵢₙ_{_{c}}²−∥τ₁−τ₂∥ₘᵢₙ_{_{c}}² is the state of a discrete, linear classification system

$${τ}^{T} x + {τ}_{0} {≷}_{{ω}_{2}}$$

that is associated with the position or location of a dual likelihood ratio:

$$ψ {=}^{Δ} \text{?} p ( {Λ}_{ψ} ( x ) \vert {ω}_{1} ) + p ( {Λ}_{ψ} ( x ) \vert {ω}_{2} ) = {ψ}_{1} + {ψ}_{2} = {\sum }_{i = 1}^{{l}_{1}} {ψ}_{1 {i}^{*}} \frac{{x}_{1 {i}^{*}}}{‖ {x}_{1 {i}^{*}} ‖} + {\sum }_{i = 1}^{{l}_{2}} {ψ}_{2 {i}^{*}} \frac{{x}_{2 {i}^{*}}}{‖ {x}_{2 {i}^{*}} ‖}$$

$$\text{?} \text{indicates text missing or illegible when filed}$$

which is constrained to be in statistical equilibrium:

$${\sum }_{i = 1}^{{l}_{1}} {ψ}_{1 {i}^{*}} \frac{{x}_{1 {i}^{*}}}{‖ {x}_{1 {i}^{*}} ‖} = {\sum }_{i = 1}^{{l}_{2}} {ψ}_{2 {i}^{*}} \frac{{x}_{2 {i}^{*}}}{‖ {x}_{2 {i}^{*}} ‖}$$

and the locus of a corresponding, linear decision boundary τ^{T}x+τ₀=0.

In summary, discrete, linear classification systems

$${τ}^{T} x + {τ}_{0} ≷ \text{?}$$

$$\text{?} \text{indicates text missing or illegible when filed}$$

have the following unique and advantageous features.

Discrete, linear classification systems are a class of high-performance learning machines, where the architecture of any given learning machine satisfies equations of statistical equilibrium along with equations of minimization of eigenenergy and Bayes' risk. Any given learning machine Λ_{τ}(x)=τ^{T}x+τ₀ is the solution to fundamental integral equations of likelihood ratios and corresponding decision boundaries, so that the learning machine finds a point of statistical equilibrium where the opposing forces and influences of a binary classification system are balanced with each other, and the eigenenergy and the corresponding Bayes' risk of the learning machine are minimized. Thereby, the generalization error of any given learning machine is a function of the amount of overlap between data distributions, where any given discrete, linear classification system

$${τ}^{T} x + {τ}_{0} ≷ \text{?}$$

$$\text{?} \text{indicates text missing or illegible when filed}$$

generates the best possible linear decision boundary for a given collection of training data.

Thus, for any given set of feature vectors drawn from statistical distributions that have similar covariance functions and constant or unchanging statistics, the generalization error of each learning machine is Bayes' error: which is the lowest error rate that can be achieved by a discriminant function and the best generalization error that can be achieved by a learning machine, so that the accuracy of any given learning machine Λ_{τ}(x)=τ^{T}x+τ₀ is the best possible for a given collection of training data. Accordingly, any given learning machine is a scalable, individual component of an optimal ensemble system, where any given ensemble system of learning machines exhibits optimal generalization performance for an M-class feature space. Optimal ensemble systems of discrete, linear discriminant functions are outlined next.

Let Λ_{τ}_{ᵢⱼ}(x) denote a discrete, linear discriminant function Λ_{τ}(x)=τ^{T}x+τ₀ for two given pattern classes ωᵢ and ωⱼ, where the feature vectors in class ω_{I} have the training label +1, and the feature vectors in class ωᵢ have the training label −1. The discriminant function Λ_{τ}_{ᵢⱼ}(x) is an indicator function χ_{ω}_{ᵢ} for feature vectors x that belong to class ωᵢ, where χ_{ω}_{ᵢ} denotes the event that an unknown feature vector xϵω₁ lies in the decision region Z₁ so that sign (Λ_{τ}_{ᵢⱼ}(x) =1.

Thereby, for any given M-class feature space {ωᵢ}ᵢ₌₁^{M}, an ensemble of M-1 discrete, linear discriminant functions Σⱼ₌₁^{M}Λ_{τ}_{ᵢⱼ} (x) for which the discriminant function Λ_{τ}_{ᵢⱼ} (x) is an indicator function χ_{ω}_{ᵢ} for class ωᵢ, provides M-1 characteristic functions χ_{ω}_{ᵢ} for feature vectors x that belong to class ωᵢ:

$$E [ {χ}_{{ω}_{i}} ] = {\sum }_{j = 1}^{M - 1} P ( sign ( {Λ}_{{τ}_{ij}} ( x ) ) = 1 ) = {\sum }_{j = 1}^{M - 1} sign ( {Λ}_{{τ}_{ij}} ( x ) ) = 1.$$

Further, because linear eigenlocus decision rules involve linear combinations of extreme vectors, scaled extreme points, class membership statistics, and regularization parameters:

$${Λ}_{τ} ( x ) = ( x - {\sum }_{i = 1}^{l} {x}_{{i}^{*}} ) {τ}_{1} - ( x - {\sum }_{i = 1}^{l} {x}_{{i}^{*}} ) {τ}_{2} + {\sum }_{i = 1}^{l} {y}_{i} ( 1 - {ξ}_{i} ) ≷ \text{?}$$

$$where$$

$${τ}_{1} = {\sum }_{i = 1}^{{l}_{1}} {ψ}_{1 {i}^{*}} {x}_{1 {i}^{*}} , and {τ}_{2} = {\sum }_{i = 1}^{{l}_{1}} {ψ}_{1 {i}^{*}} {x}_{1 {i}^{*}} , \\ \text{?} \text{indicates text missing or illegible when filed}$$

it follows that linear combinations of linear eigenlocus discriminant functions can be used to build optimal statistical pattern recognition systems P [symbol] (x), where the overall system complexity is scale-invariant for the feature space dimension and the number of pattern classes. Thus, linear eigenlocus decision rules Λ_{τ}(x)=τ^{T}x+τ₀ are scalable modules for optimal linear classification systems.

Given that a discrete, linear discriminant function Λ_{τ}(x)=τ^{T}x+τ₀ is an indicator function χ_{ω}_{ᵢ} for any given class of feature vectors ωᵢ that have the training label +1, it follows that the decision function

$$sign \begin{matrix}( {Λ}_{τ} ( x ) ) & τ x + {τ}_{0}\end{matrix} ) ,$$

where

$$sign ( x ) \text{?}$$

$$\text{?} \text{indicates text missing or illegible when filed}$$

for x≠0, provides a natural means for discriminating between multiple classes of data, where decisions can be made that are based on the largest probabilistic output of decision banks DB_{ω}_{ᵢ}(x) formed by linear combinations of linear eigenlocus decision functions sign(Λₓ(x)):

DB_{ω}_{ᵢ}(x)=Σⱼ₌₁^{M-1}sign(τ^{T}x+τ₀)

where the decision bank DB_{ω}_{_{τ}}(x) for a pattern class ωᵢ is an ensemble Σⱼ₌₁^{M-1}sign(Λ_{τ}(x)) of M−1 decision functions {sign(Λ_{τ}_{ⱼ}(x))}ⱼ₌₁^{M-1} for which the pat ern vectors in the given class ω₁ have the training label +1, and the pattern vectors in all of the other pattern classes have the training label −1.

The design of optimal, statistical pattern recognition systems P [symbol] (x) involves designing M decision banks, where each decision bank contains an ensemble of M−1 linear decision functions sign(Λ_{τ}(x)), and each decision function is determined by a feature extractor and a linear discriminant function Λ_{τ}(x). A feature extractor generates d-dimensional feature vectors from collections of digital signals, digital waveforms, digital images, or digital videos for all of the M pattern classes.

Take M sets of d-dimensional feature vectors that have been extracted from collections of digital signals, digital waveforms, digital images, or digital videos for M pattern classes. Optimal, statistical pattern recognition systems P [symbol] (x)are produced in the following manner.

Produce a decision bank DB_{ω}_{ᵢ}(Σⱼ₌₁^{M-1}sign(Λ_{τ}_{ⱼ}(x)) for each pattern class ω₁ that consists of a bank or ensemble sign Σⱼ₌₁^{M-1}sign(Λ_{τ}_{ⱼ}(x)) of M−1 decision functions {sign(Λ_{τ}_{ⱼ}(x))}ⱼ₌₁^{M-1}. Accordingly, generate M−1 linear discriminant functions Λ_{τ}(x), where the feature vectors in the given class ω₁ have the training label +1 and the feature vectors in all of the other pattern classes have the training label −1.

An optimal, statistical pattern recognition system [symbol] (X)

$$( x ) = {\{ {DB}_{{ω}_{i}} ( {\sum }_{j = 1}^{M - 1} sign ( {Λ}_{{τ}_{j}} ( x ) ) ) \}}_{i = 1}^{M}$$

contains M decision banks {DB_{ω}_{ᵢ}(x)}ᵢ₌₁^{M}, i.e., M ensembles Σⱼ₌₁^{M-1}sign(Λ_{τ}_{ⱼ}(x)) of optimal decision functions sign(Λ_{τ}(x)), all of which provide a set of M×(M−1) decision statistics

$${\{ sign ( {Λ}_{{τ}_{j}} ( x ) ) \}}_{j = 1}^{M \times ( M - 1 )}$$

that minimize the probability of decision error for an M-class feature space, such that the maximum value selector of the pattern recognition system [symbol] (x) chooses the pattern class ω₁ for which a decision bank DB_{ω}_{ᵢ} (x) has the maximum probabilistic output:

$$( x ) = \begin{matrix}Arg Max \\ i ∈ 1 , …\end{matrix} ( {DB}_{{ω}_{i}} ( x ) ) ,$$

where the probabilistic output of each decision bank DB_{ω}_{ᵢ}(x) is determined by a set of M−1 characteristic functions:

$$E [ {χ}_{{ω}_{i}} ] = {\sum }_{j = 1}^{M - 1} P ( sign ( {Λ}_{{τ}_{ij}} ( x ) ) = 1 ) = {\sum }_{j = 1}^{M - 1} sign ( {Λ}_{{τ}_{ij}} ( x ) ) = 1.$$

For feature vectors drawn from statistical distributions that have similar covariance functions and constant or unchanging mean and covariance statistics, statistical pattern recognition systems [symbol] (x) that are formed by the ensembles of linear decision functions outlined above generate a set of linear decision boundaries and decision statistics that minimize the probability of decision error, i.e., the Bayes' error. Accordingly, any statistical pattern recognition system [symbol] (x) that is formed by the ensembles of linear decision functions outlined above achieves Bayes' error, which is the lowest error rate that can be achieved by a discriminant function and the best generalization error that can be achieved by a learning machine.

Feature vectors that have been extracted from collections of digital signals, digital waveforms, digital images, or digital videos can be fused with each other by designing decision banks for data obtained from different sources and combining the outputs of the decision banks. The method is outlined for two different data sources and is readily extended to L sources of data.

Take M sets of d-dimensional and n-dimensional feature vectors that have been extracted from two different collections of digital signals, digital waveforms, digital images, or digital videos for M pattern classes. Optimal, statistical pattern recognition systems [symbol] (x) are produced in the following manner.

Given M pattern classes {ωᵢ}ᵢ₌₁^{M}, let DB_{ω}_{ᵢ₁} and DB_{ω}_{ᵢ₂} denote the decision banks for the d-dimensional and n-dimensional feature vectors respectively, where feature vectors in class ωᵢ have the training label +1 and feature vectors in all of the other pattern classes have the training label −1. Produce the decision banks

DB_{ω}_{ᵢ₁}(Σⱼ₌₁^{M-1}sign(Λ_{τ}_{ᵢ}(x)) and DB_{ω}_{ᵢ₂}(Σⱼ₌₁^{M-1}sign(Λ_{τ}_{ⱼ}(x))

for each pattern class ω₁, where DB_{ω}_{ᵢ₁} and DB_{ω}_{ᵢ₂} consist of a bank or ensemble Σⱼ₌₁^{M-1}sign(Λ_{τ}_{ⱼ}(x)) of M−1 linear decision functions sign(Λ_{τ}(x)). Accordingly, for each decision bank, generate M−1 linear discriminant functions Λ_{τ}(x), where the feature or pattern vectors in the given class ω₁ have the training label +1 and the feature or pattern vectors in all of the other pattern classes have the training label −1.

For each pattern class ω₁, the decision banks DB_{ω}_{ᵢ₁} DB_{ω}_{ᵢ₂} and generate two sets of M−1 decision statistics

$${DB}_{{ω}_{i 1}} ( x ) = {\{ sign ( {Λ}_{{τ}_{j}} ( x ) ) \}}_{j = 1}^{M - 1}$$

$$and$$

$${DB}_{{ω}_{i 2}} ( x ) = {\{ sign ( {Λ}_{{τ}_{j}} ( x ) ) \}}_{j = 1}^{M - 1}$$

such that the maximum value selector of the statistical pattern recognition system [symbol] (x)

$$( x ) = {\{ {\sum }_{j = 1}^{2} {DB}_{{ω}_{ij}} ( {\sum }_{k = 1}^{M - 1} sign ( {Λ}_{{τ}_{k}} ( x ) ) ) \}}_{i = 1}^{M}$$

chooses the pattern class ωᵢ for which the fused decision banks Σⱼ₌₁²DB_{ω}_{ᵢⱼ}(x) have the maximum probabilistic output:

$$( x ) = \begin{matrix}Arg Max \\ i ∈ 1 , …\end{matrix} ( {\sum }_{j = 1}^{2} {DB}_{{ω}_{ij}} ( x ) ) .$$

The method is readily extended to L different data sources. Given that fusion of decision banks based on different data sources involves linear combinations of decision banks, it follows that optimal, statistical pattern recognition systems [symbol] (x) can be designed for feature vectors that have been extracted from L different sources of digital data:

$$( x ) = {\{ {\sum }_{j = 1}^{L} {DB}_{{ω}_{ij}} ( {\sum }_{k = 1}^{M - 1} sign ( {Λ}_{{τ}_{k}} ( x ) ) ) \}}_{i = 1}^{M}$$

such that the maximum value selector of an optimal, statistical pattern recognition system [symbol] (x) chooses the pattern class ωᵢ for which the L fused decision banks Σⱼ₌₁²DB_{ω}_{ᵢⱼ}(x)have the maximum probabilistic output:

$$( x ) = \begin{matrix}Arg Max \\ i ∈ 1 , …\end{matrix} ( {\sum }_{j = 1}^{L} {DB}_{{ω}_{ij}} ( x ) ) .$$

For the problem of learning discriminant functions and decision boundaries, an important problem involves the identification and exploitation of distinguishing features that are simple to extract, invariant to irrelevant transformations, insensitive to noise, and useful for discriminating between objects in different categories. Useful sets of distinguishing features for discrimination tasks must exhibit sufficient class separability: i.e., a negligible overlap exists between all data distributions. Further, the criteria to evaluate the effectiveness of feature vectors must be a measure of the overlap or class separability among data distributions and not a measure of fit such as the mean-square error of a statistical model.

Because linear eigenlocus classification systems optimize trade-offs between Bayes' counter risks and Bayes' risks for any data distributions that have similar covariance functions, linear eigenlocus classification systems provide measures of data distribution overlap and Bayes' error rate for any two given sets of feature vectors drawn from statistical distribution that have similar covariance functions and constant or unchanging mean and covariance statistics. Accordingly, linear eigenlocus classification systems can be used to predict how well they will generalize to new patterns.

Linear eigenlocus decision functions provide a practical statistical gauge for measuring data distribution overlap and Bayes' error rate for two given sets of feature or pattern vectors. To measure Bayes' error rate and data distribution overlap, generate a linear eigenlocus classification system

$${τ}^{T} x + {τ}_{0} {≷}_{{ω}_{2}}$$

using feature vectors that have been extracted from any given collections of digital signals, digital waveforms, digital images, or digital videos for two pattern classes. While equal numbers of training examples are not absolutely necessary, the number of training examples from each of the pattern classes should be reasonably balanced with each other.

Apply the decision function sign(τ^{T}x+τ₀) to a collection of feature vectors which have not been used to build the classification system

$${τ}^{T} x + {τ}_{0} {≷}_{{ω}_{2}} .$$

Compare tree Known class memberships to the predicted class memberships, and determine the error rate for each pattern class based on the frequency of incorrect predictions for each pattern class. Determine the data distribution overlap and the Bayes' error rate based on the error rates of the collection of unknown feature vectors.

If data collection is cost prohibitive, use k-fold cross validation, where a collection of feature vectors is split randomly into k partitions. Generate a linear classification system

$${τ}^{T} x + {τ}_{0} {≷}_{{ω}_{2}}$$

using a data set consisting of k−1 of the original k parts and use the remaining portion for testing. Repeat this process k times. Bayes' error rate and data distribution overlap is the average over the k test runs.

Linear decision functions sign(τ^{T}x+τ₀) can also be used to identify homogeneous data distributions. Generate a linear classification system

$${τ}^{T} x + {τ}_{0} {≷}_{{ω}_{2}}$$

using samples drawn from two distributions. Apply the decision function sign(τ^{T}x+τ₀) to samples which have not been used to build the classification system

$${τ}^{T} x + {τ}_{0} {≷}_{{ω}_{2}} .$$

Given homogeneous data distributions, essentially all of the training data are transformed into constrained, primal principal eigenaxis components, such that the error rate of the linear classification system

$${τ}^{T} x + {τ}_{0} {≷}_{{ω}_{2}}$$

is ≈50%.

If data collection is cost prohibitive, use k-fold cross validation, where a collection of feature vectors is split randomly into k partitions. Generate a linear classification system

$${τ}^{T} x + {τ}_{0} {≷}_{{ω}_{2}}$$

using a aata set consisting of k−1 of the original k parts and use the remaining portion for testing. Repeat this process k times. Bayes' error rate and data distribution overlap is the average over the k test runs.

The machine learning methods disclosed herein may be readily utilized in a wide variety of applications to construct optimal statistical pattern recognition systems or optimal linear classification systems, where the data corresponds to a phenomenon of interest, e.g., outputs of sensors: radar and hyperspectral or multispectral images, biometrics, digital communication signals, text, images, digital waveforms, etc. More specifically, the applications include, for example and without limitation, general pattern recognition (including image recognition, waveform recognition, object detection, spectrum identification, and speech and handwriting recognition, data classification, (including text, image, and waveform categorization), bioinformatics (including automated diagnosis systems, biological modeling, and bioimaging classification), etc. One skilled in the art will recognize that any suitable computer system may be used to execute the machine learning methods disclosed herein. The computer system may include, without limitation, a mainframe computer system, a workstation, a personal computer system, a personal digital assistant, or other device or apparatus having at least one processor that executes instructions from a memory medium. The computer system may further include a display device or monitor for displaying operations associated with the learning machine and one or more memory mediums on which computer programs or software components may be stored. In addition, the memory medium may be entirely or partially located in one or more associated computers or computer systems which connect to the computer system over a network, such as the Internet.

The machine learning method described herein may also be executed in hardware, a combination of software and hardware, or in other suitable executable implementations.

The learning machine methods implemented in software may be executed by the processor of the computer system or the processor or processors of the one or more associated computer systems connected to the computer system.

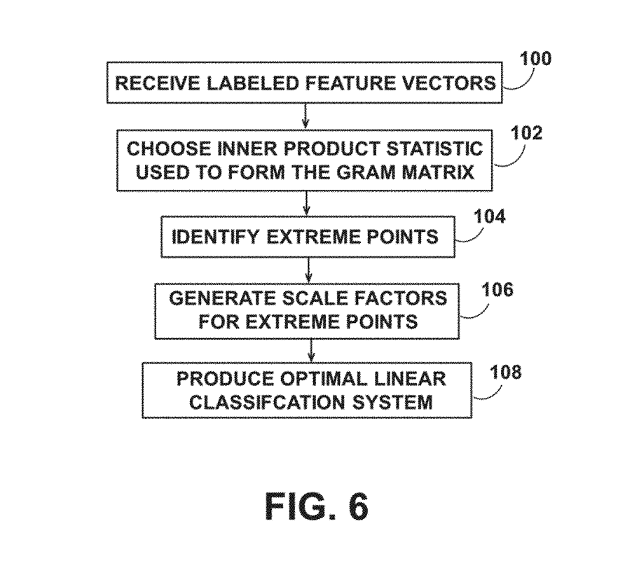

FIG. 6 illustrates a flowchart of processing performed in training a linear classifier in accordance with the preferred embodiment. At step 100, a set of labeled feature vectors is received. At step 102, the inner product statistic used to form the Gram matrix is chosen. At step 104, general processing is being done on the training data to identity the extreme feature vectors. At step 106, general processing is being done on the extreme points to obtain scale factors for the extreme vectors. At step 108, general processing is being done to produce the optimal linear classification system.

A computer-implemented, optimal linear classification system is obtained by solving the inequality constrained optimization problem:

minΨ(τ)=∥τ∥²/2+C/2Σᵢ₌₁^{N}ξᵢ², s.t. yᵢ(xᵢ^{T}τ+τ₀)≥1−ξᵢ, ξᵢ≥0,i=1, (1.54)

The strong dual solution of Eq. (1.54) is obtained by solving a dual optimization problem:

$$max Ξ ( ψ ) = {\sum }_{i = 1}^{N} {ψ}_{i} - {\sum }_{i , j = 1}^{N} {ψ}_{i} {ψ}_{j} {y}_{i} {y}_{j} \frac{{x}_{i}^{T} {x}_{j} + {δ}_{ij} / C}{2} , \qquad ( 1.55 )$$

which is subject to the algebraic constraints Σᵢ₌₁Ψᵢyᵢ=0, and Ψᵢ≥0, where δᵢⱼ is the Kronecker δ defined as unity for i=j and 0 otherwise. Equation (1.55) is a quadratic programming problem that can be written in vector notation by letting

$$Q {=}^{Δ} \text{?} {:}^{T} and X {= \text{?}}^{Δ} \text{?} , \\ \text{?} \text{indicates text missing or illegible when filed}$$

where D is an N×N diagonal matrix of training labels (class membership statistics) yᵢ and the N×d data matrix X is

$$X = ( \begin{matrix}{x}_{1} , & {x}_{2} , & …\end{matrix} \text{?} , \\ \text{?} \text{indicates text missing or illegible when filed}$$

The matrix version of the Lagrangian dual problem:

$$max Ξ ( ψ ) = {1}^{T} ψ - \frac{{ψ}^{T} Q ψ}{2}$$

is subject to the constraints Ψ^{T}y=0 and Ψᵢ≥0.

In order to solve Eq. (1.54), values for the parameters ξᵢ and C must be properly specified.

For N training vectors of dimension d, where d<N, all of the regularization parameters {ξᵢ}ᵢ₌₁^{N} in Eq. (1.54) and all of its derivatives are set equal to a very small value: ξᵢ=ξ<<. The regularization constant C is set equal to

$$\frac{1}{ξ} : C = \frac{1}{ξ} .$$

For N training vectors of dimension d, where N<d, all of the regularization parameters {ξᵢ}ᵢ₌₁^{N} in Eq. (1.54) and all of its derivatives are set equal to zero: ξᵢξ=0. The regularization constant C is set equal to infinity: C=∞.

Solving Eq. (1.55) produces a principal eigenvector Ψ of N parameters. A linear discriminant function

D(x)=τ^{T}x+τ₀

is formed by setting

τ=X^{T}Ψ,

where X≙, D_{y} is an N×N diagonal matrix of training labels (class membership statistics) yᵢ and X is an N×d data matrix

$$X = ( \begin{matrix}{x}_{1} , & {x}_{2} , & …\end{matrix} \text{?} \\ \text{?} \text{indicates text missing or illegible when filed}$$

and by setting

τ₀=Σᵢ₌₁^{l}yᵢ(1−ξᵢ)−Σᵢ₌₁^{l}x_{i*}^{T}τ,

where the vector x_{i*} is correlated with Ψ_{1*}>0.

A linear decision function sign(D(x)) is formed by the vector expression

(sign(D(x) [symbol] τx+τ₀),

where

$$sign ( x ) \text{?}$$

$$\text{?} \text{indicates text missing or illegible when filed}$$

for x≠0.

Equal numbers of training examples are not absolutely necessary for optimal estimates of linear decision boundaries. Even so, the number of training examples from each of the pattern classes should be reasonably balanced with each other. Therefore, it is recommended, but is not absolutely necessary that Eq. (1.55) be applied to equal numbers of training examples from each pattern class.

Linear eigenlocus transforms involve solving variants of the inequality constrained optimization problem for linear kernel support vector machines (SVMs): Software for linear eigenlocus transforms can be obtained by using software packages that solve quadratic programming problems, or via LIBSVM (A Library for Support Vector Machines), SVMlight (an implementation of Support Vector Machines (SVMs) in C), or MATLAB SVM toolboxes.

What is claimed is:

1. A computer implemented method of linear classification, comprising:
transforming two sets of feature vectors that are identified as members of two predefined classes into a data-driven likelihood ratio test that is based on a dual locus of likelihoods and principal eigenaxis components, formed by a locus of weighted extreme points, where each weight specifies a class membership statistic and a conditional density for an extreme point, which is located in either an overlapping region or a tail region between two data distributions, and each weight determines the magnitude and the total allowed eigenenergy of an extreme vector, such that the dual locus of likelihoods and principal eigenaxis components is the basis of an optimal linear classification system that exhibits the highest accuracy and achieves Bayes' error rate for feature vectors drawn from statistical distributions that have similar covariance functions and constant or unchanging mean and covariance statistics;
according to a system of fundamental, data-driven, vector-based locus equations of binary classification for a linear classification system in statistical equilibrium that determines fundamental equations of statistical equilibrium along with fundamental equations of minimization of eigenenergy and Bayes' risk: which are satisfied by a data-driven likelihood ratio test that contains Bayes' likelihood ratio and delineates an optimal linear decision boundary; and
identifying class memberships of unknown feature vectors according to the output of the optimal linear classification system.

2. The method of claim 1, wherein the feature vectors are extracted from digital images or digital videos.

3. The method of claim 1, wherein the feature vectors are extracted from digital signals or digital waveforms.

4. A computer implemented method of multiclass linear classification, comprising:
receiving M sets of d-dimensional feature vectors that have been extracted from a common digital data source; and
producing an ensemble of M−1 linear classifiers for each of the M pattern classes by transforming M sets of d-dimensional feature vectors, where the feature vectors in an ensemble of M−1 linear classifiers for a given pattern class have the class membership statistic +1 and the feature vectors in all of the other pattern classes have the class membership statistic −1, into M−1 data-driven likelihood ratio tests, each of which is an indicator function for a given pattern class that is based on a dual locus of likelihoods and principal eigenaxis components, formed by a locus of weighted extreme points, where each weight specifies a class membership statistic and a conditional density for an extreme point, which is located in either an overlapping region or a tail region between two data distributions, and each weight determines the magnitude and the total allowed eigenenergy of an extreme vector, such that each dual locus of likelihoods and principal eigenaxis components is the basis of an optimal linear classification system that exhibits the highest accuracy and achieves Bayes' error rate for feature vectors drawn from statistical distributions that that have similar covariance functions and constant or unchanging means and covariance statistics, where each optimal linear classification system is an indicator function for a given pattern class;
according to a system of fundamental, data-driven, vector-based locus equations of binary classification for a linear classification system in statistical equilibrium that determines fundamental equations of statistical equilibrium along with fundamental equations of minimization of eigenenergy and Bayes' risk, which are satisfied by a data-driven likelihood ratio test that contains Bayes' likelihood ratio and delineates an optimal linear decision boundary; and
forming linear combinations of the M−1 linear classifiers for each of the M pattern classes to produce M ensembles of M−1 linear classification systems; and
forming linear combinations of the M ensembles to produce an M-class linear classification system; and
identifying class memberships of unknown feature vectors according to the output of the ensemble of M−1 linear classifiers.

5. The method of claim 4, wherein the feature vectors are extracted from digital images or digital videos.

6. The method of claim 4, wherein the feature vectors are extracted from digital signals or digital waveforms.

7. A computer implemented method of fusing M-class linear classification systems using feature vectors that have been extracted from two different types of data sources, comprising:
receiving M sets of d-dimensional feature vectors and M sets of n-dimensional feature vectors that have been extracted from two different sources of digital data; and
producing two ensembles of M−1 linear classifiers for each of the M pattern classes by transforming the M sets of d-dimensional feature vectors and the M sets of n-dimensional feature vectors, where the feature vectors in an ensemble of M−1 quadratic classifiers for a given pattern class have the class membership statistic +1 and the feature vectors in all of the other pattern classes have the class membership statistic −1, into two ensembles of M−1 data-driven likelihood ratio tests, where each data-driven likelihood ratio test is an indicator function for a given pattern class that is based on a dual locus of likelihoods and principal eigenaxis components, formed by a locus of weighted extreme points, where each weight specifies a class membership statistic and a conditional density for an extreme point, which is located in either an overlapping region or a tail region between two data distributions, and each weight determines the magnitude and the total allowed eigenenergy of an extreme vector, such that each dual locus of likelihoods and principal eigenaxis components is the basis of an optimal linear classification system that exhibits the highest accuracy and achieves Bayes' error rate for feature vectors drawn from statistical distributions that have similar covariance functions and constant or unchanging means and covariance statistics, where each optimal linear classification system is an indicator function for a given pattern class;
according to a system of fundamental, data-driven, vector-based locus equations of binary classification for a linear classification system in statistical equilibrium that determines fundamental equations of statistical equilibrium along with fundamental equations of minimization of eigenenergy and Bayes' risk, which are satisfied by a data-driven likelihood ratio test that contains Bayes' likelihood ratio and delineates an optimal linear decision boundary; and
forming linear combinations of both ensembles of M−1 linear classifiers for each of the M pattern classes to produce two sets of M ensembles of M−1 linear classification systems; and
forming linear combinations of the two sets of M ensembles of M−1 linear classification systems for each of the M pattern classes to produce an M-class linear classification system; and
identifying class memberships of unknown feature vectors according to the output of the fused ensembles of M−1 linear classifiers.

8. The method of claim 7, wherein feature vectors are extracted from two different sources of digital data that include digital images, digital videos, digital signals, and digital waveforms.

9. The method of claim 7, wherein feature vectors are extracted from multiple sources of digital data that include digital images, digital videos, digital signals, and digital waveforms.

10. A computer implemented method of using linear classification systems to measure data distribution overlap and Bayes' error rate for two given sets of feature vectors, comprising:
transforming two sets of feature vectors that are identified as members of two predefined classes into a practical statistical gauge, which accurately measures the data distribution overlap and the Bayes' error rate for the two given sets of feature vectors, that consists of a data-driven likelihood ratio test that is based on a dual locus of likelihoods and principal eigenaxis components, formed by a locus of weighted extreme points, where each weight specifies a class membership statistic and a conditional density for an extreme point, which is located in either an overlapping region or a tail region between two data distributions, and each weight determines the magnitude and the total allowed eigenenergy of an extreme vector, such that the dual locus of likelihoods and principal eigenaxis components is the basis of an optimal linear classification system that exhibits the highest accuracy and achieves Bayes' error rate for feature vectors drawn from statistical distributions that have similar covariance functions and constant or unchanging mean and covariance statistics;
according to a system of fundamental, data-driven, vector-based locus equations of binary classification for a linear classification system in statistical equilibrium that determines fundamental equations of statistical equilibrium along with fundamental equations of minimization of eigenenergy and Bayes' risk, which are satisfied by a data-driven likelihood ratio test that contains Bayes' likelihood ratio and delineates an optimal linear decision boundary; and
using the linear classification system to identify the class memberships of a collection of unknown feature vectors according to the output of the optimal linear classification system, where each unknown feature vector is identified as a member of one of the two predefined classes, and
comparing the known class memberships to the predicted class memberships; and
determining the error rate for each pattern class based on the frequency of incorrect predictions for each pattern class; and
determining the data distribution overlap and the Bayes' error rate based on the error rates of the collection of unknown feature vectors.

11. The method of claim 10, wherein the feature vectors are extracted from digital data sources that include digital images, digital videos, digital signals, or digital waveforms.

12. A computer implemented method of using optimal linear classification systems to identify homogeneous data distributions, comprising:
transforming two sets of feature vectors that are identified as members of two predefined classes into a practical statistical gauge, which accurately measures the data distribution overlap and the Bayes' error rate for two given sets of feature vectors that are drawn from homogenous data distributions, that consists of a data-driven likelihood ratio test that is based on a dual locus of likelihoods and principal eigenaxis components, formed by a locus of weighted extreme points, where each weight specifies a class membership statistic and a conditional density for an extreme point, which is located in either an overlapping region or a tail region between two data distributions, and each weight determines the magnitude and the total allowed eigenenergy of an extreme vector, such that the dual locus of likelihoods and principal eigenaxis components is the basis of an optimal linear classification system that exhibits the highest accuracy and achieves Bayes' error rate of 50% for feature vectors drawn from homogeneous data distributions, where all of the feature vectors drawn from homogenous data distributions are extreme vectors;
according to a system of fundamental, data-driven, vector-based locus equations of binary classification for a linear classification system in statistical equilibrium that determines fundamental equations of statistical equilibrium along with fundamental equations of minimization of eigenenergy and Bayes' risk: which are satisfied by a data-driven likelihood ratio test that contains Bayes' likelihood ratio and delineates an optimal linear decision boundary; and
using the optimal linear classification system to identify the class memberships of a collection of unknown feature vectors according to the output of the optimal linear classification system, where each unknown feature vector is identified as a member of one of the two predefined classes; and
comparing the known class memberships to the predicted class memberships; and
determining the error rate for each pattern class based on the frequency of incorrect predictions for each pattern class; and
determining the data distribution overlap and the Bayes' error rate based on the number of extreme points and the error rates of the collection of unknown feature vectors; and
determining if the two sets of features vectors are drawn from similar statistical distributions based on the data distribution overlap and the Bayes' error rate.
